(19) United States
(12) Patent Application Publication
(10) Pub. No.: US 2026/0212611 A1
(43) Pub. Date: Jul. 23, 2026

(54) RENDERING IMAGE DATA FOR EXTENDED REALITY

(71) Applicant: QUALCOMM Incorporated, San Diego, CA (US)

(72) Inventors: Varun Amar REDDY, San Diego, CA (US); Sony AKKARAKARAN, Poway, CA (US)

(21) Appl. No.: 19/034,464

(22) Filed: Jan. 22, 2025

(51) Int. Cl. G06T 19/00; G02B 27/00

(52) U.S. Cl. CPC G06T 19/006; G02B 27/0093

(57) ABSTRACT

Systems and techniques are described herein for generating one or more images. For instance, a method for generating one or more images is provided. The method may include obtaining device-pose data describing a pose of a device; determining a predicted pose of the device based on the pose of the device; determining a probability associated with the predicted pose; based on the probability, rendering image data including virtual content from a viewpoint relative to the predicted pose; and transmitting the image data to the device

### TECHNICAL FIELD

The present disclosure generally relates to extended reality (XR). For example, aspects of the present disclosure include systems and techniques for rendering image data for XR applications.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto a user's view of a real-world environment.

For example, an XR head-mounted device (HMD) may include a display that allows a user to view the user's real-world environment through a display of the HMD (e.g., a transparent display). The XR HMD may display virtual content at the display in the user's field of view overlaying the user's view of their real-world environment. Such an implementation may be referred to as “see-through” XR. As another example, an XR HMD may include a scene-facing camera that may capture images of the user's real-world environment. The XR HMD may modify or augment the images (e.g., adding virtual content) and display the modified images to the user. Such an implementation may be referred to as “pass through” XR or as “video see through (VST).” The user can generally change their view of the environment interactively, for example by tilting or moving the XR HMD.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating one or more images. According to at least one example, a method is provided for generating one or more images. The method includes: obtaining device-pose data describing a pose of a device; determining a predicted pose of the device based on the pose of the device; determining a probability associated with the predicted pose; based on the probability, rendering image data including virtual content from a viewpoint relative to the predicted pose; and transmitting the image data to the device.

In another example, an apparatus for generating one or more images is provided that includes at least one memory and at least one processor (e.g., configured in circuitry) coupled to the at least one memory. The at least one processor configured to: obtain device-pose data describing a pose of a device; determine a predicted pose of the device based on the pose of the device; determine a probability associated with the predicted pose; based on the probability, render image data including virtual content from a viewpoint relative to the predicted pose; and cause at least one transmitter to transmit the image data to the device.

In another example, a non-transitory computer-readable medium is provided that has stored thereon instructions that, when executed by one or more processors, cause the one or more processors to: obtain device-pose data describing a pose of a device; determine a predicted pose of the device based on the pose of the device; determine a probability associated with the predicted pose; based on the probability, render image data including virtual content from a viewpoint relative to the predicted pose; and cause at least one transmitter to transmit the image data to the device.

In another example, an apparatus for generating one or more images is provided. The apparatus includes: means for obtaining device-pose data describing a pose of a device; means for determining a predicted pose of the device based on the pose of the device; means for determining a probability associated with the predicted pose; means for based on the probability, rendering image data including virtual content from a viewpoint relative to the predicted pose; and means for transmitting the image data to the device.

In another example, a method is provided for generating one or more images. The method includes: obtaining, at a first extended reality (XR) device, image data, wherein the image data is based on virtual content associated with a location, wherein the image data is rendered at a server based on a predicted pose of the first XR device and based on a probability associated with the predicted pose; and transmitting the image data from the first XR device to a second XR device in the location.

In another example, an apparatus for generating one or more images is provided that includes at least one memory and at least one processor (e.g., configured in circuitry) coupled to the at least one memory. The at least one processor configured to: obtain, at a first extended reality (XR) device, image data, wherein the image data is based on virtual content associated with a location, wherein the image data is rendered at a server based on a predicted pose of the first XR device and based on a probability associated with the predicted pose; and cause at least one transmitter to transmit the image data from the first XR device to a second XR device in the location.

In another example, a non-transitory computer-readable medium is provided that has stored thereon instructions that, when executed by one or more processors, cause the one or more processors to: obtain, at a first extended reality (XR) device, image data, wherein the image data is based on virtual content associated with a location, wherein the image data is rendered at a server based on a predicted pose of the first XR device and based on a probability associated with the predicted pose; and cause at least one transmitter to transmit the image data from the first XR device to a second XR device in the location.

In another example, an apparatus for generating one or more images is provided. The apparatus includes: means for obtaining, at a first extended reality (XR) device, image data, wherein the image data is based on virtual content associated with a location, wherein the image data is rendered at a server based on a predicted pose of the first XR device and based on a probability associated with the predicted pose; and means for transmitting the image data from the first XR device to a second XR device in the location.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2 is a diagram illustrating another example extended reality (XR) system, according to aspects of the disclosure;

FIG. 3 is a diagram illustrating yet another example extended-reality (XR) system, according to aspects of the disclosure;

FIG. 4 is a block diagram illustrating an architecture of an example extended reality (XR) system, in accordance with some aspects of the disclosure;

FIG. 5 is a block diagram illustrating an architecture of a simultaneous localization and mapping (SLAM) system, according to various aspects of the present disclosure;

FIG. 6 is a block diagram illustrating an example system for extended reality, according to various aspects of the present disclosure;

FIG. 7 is a diagram of a 3D space including a virtual object and representations of various poses from which virtual object may be viewed, according to various aspects of the present disclosure;

FIG. 8A includes a process diagram illustrating an example process of rendering image data for XR, according to various aspects of the present disclosure;

FIG. 8B includes a process diagram illustrating an example process of rendering image data for XR, according to various aspects of the present disclosure;

FIG. 9 includes two diagrams, each illustrating a respective scenario for the systems and techniques may determine to render or pre-render image data, according to various aspects of the present disclosure;

FIG. 10 includes a process diagram illustrating an example process of rendering image data for XR, according to various aspects of the present disclosure;

FIG. 11 is a diagram including an example system for rendering image data, according to various aspects of the present disclosure;

FIG. 12 is a diagram illustrating an example extended-reality (XR) system, according to aspects of the disclosure;

FIG. 13 is a flow diagram illustrating an example process for generating one or more images, in accordance with aspects of the present disclosure;

FIG. 14 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects, devices, and/or points in the physical world. For example, an XR system can use tracking information to calculate the relative pose of devices, objects, and/or points of the real-world environment in order to match the relative position and movement of the devices, objects, and/or points of the real-world environment. In some examples, the XR system can use the pose and movement of one or more devices, objects, and/or points of the real-world environment to render content relative to the real-world environment in a convincing manner. The relative pose information can be used to match virtual content with the user's perceived motion and the spatio-temporal state of the devices, objects, and/or points of the real-world environment. Matching virtual content to devices, objects, and points of the real-world environment may be referred to as “anchoring.” For example, a virtual object may be anchored to a device, object, or point of the real-world environment. In some cases, an XR system can track parts of the user (e.g., a hand and/or fingertips of a user) to allow the user to interact with items of virtual content.

In the present disclosure, the term “pose” may refer to a position and orientation. Poses may be determined according to six degrees of freedom including three translational degrees of freedom (e.g., x, y, and z dimensions) and three rotational degrees of freedom (e.g., roll, pitch, and yaw).

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

Systems, apparatuses, methods (also referred to as processes), and computer-readable media (collectively referred to herein as “systems and techniques”) are described herein for rendering image data for XR applications. For example, the systems and techniques described herein may relate to pre-rendering and/or hybrid rendering of the visual content (e.g., image data), based on the location and/or orientation of one or more XR devices. Pre-rendering helps reduce latency, conserve power, and can achieve higher graphics quality (since computations can be performed beforehand, for example, not in real time).

In the present disclosure, the terms “prerendering,” “pre-rendering,” “preemptive rendering,” “predictive rendering” and like terms may refer to rendering image data based on virtual content (e.g., rendering a 2D image of a simulated 3D object) before the image data is to be displayed. For example, a server may render image data of a virtual object from a perspective before an XR device has the perspective relative to the virtual object (e.g., based on a probability that the XR device will have the perspective relative to the virtual object). For instance, a person may use an XR device while walking through a park. The park may be associated with 3D virtual objects. A server may render 2D images of the 3D virtual objects from positions that the user will likely be in while the user walks through the park.

The systems and techniques may pre-emptively render images of virtual content at a server based on the location and/or orientation or one or more XR devices. The location and/or orientation measurements may be obtained using RF technologies such as ultra-wideband (UWB), Bluetooth, Institute of Electrical and Electronics Engineers (IEEE) 802.11 (WiFi), new radio side link (NR-SL), etc. Additionally or alternatively, the location and/or orientation measurements may be determined using inertial measurement units (IMUs) and/or visual odometry techniques.

The systems and techniques relate to predictive rendering by (e.g., a server). The systems and techniques include pre-rendering visual content at a server and hybrid rendering (e.g., rendering tasks shared between a server and an XR device). Additionally, some aspects of the systems and techniques include rendering visual content at an XR device (e.g., with no server assistance).

Various aspects of the application will be described with respect to the figures below.

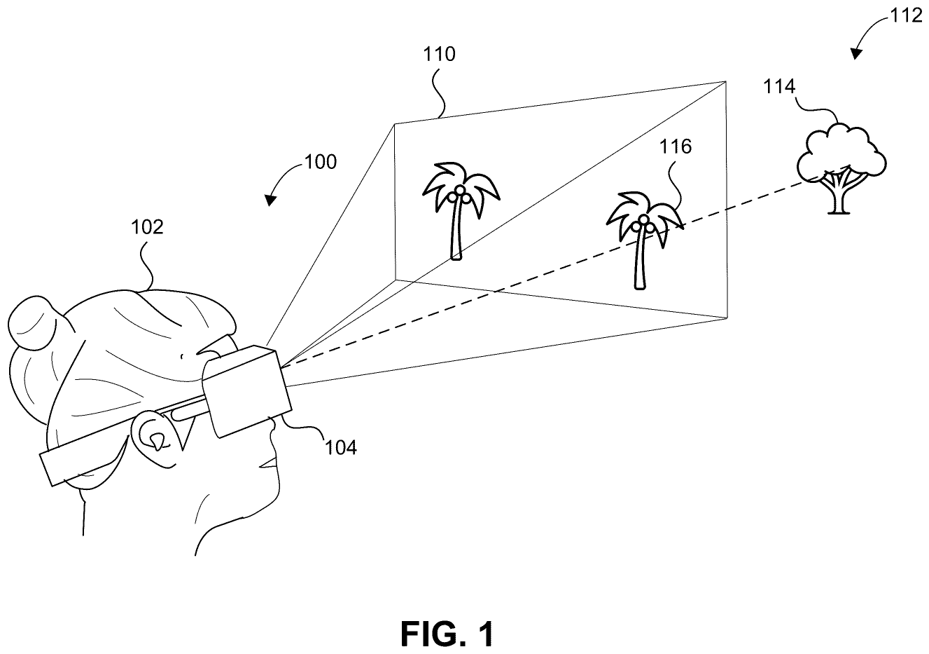

FIG. 1 is a diagram illustrating an example extended-reality (XR) system 100, according to aspects of the disclosure. As shown, XR system 100 includes an XR device 104. XR device 104 may implement, as examples, image-capture, object-detection, object-tracking, gaze-tracking, view-tracking, localization (e.g., determining a location of XR device 104), pose-tracking (e.g., tracking a pose of XR device 104), content-generation, content-rendering, computational, communicational, and/or display aspects of extended reality, including virtual reality (VR), augmented reality (AR), and/or mixed reality (MR).

For example, XR device 104 may include one or more scene-facing cameras that may capture images of a scene 112 in which a user 102 uses XR device 104. XR device 104 may detect objects (e.g., object 114) in scene 112 based on the images of scene 112. In some aspects, XR device 104 may include one or more user-facing cameras that may capture images of eyes of user 102. XR device 104 may determine a gaze of user 102 based on the images of user 102. In some aspects, XR device 104 may determine an object of interest (e.g., object 114) in scene 112 (e.g., based on the gaze of user 102, based on object recognition, and/or based on a received indication regarding object 114). XR device 104 may obtain and/or render XR content 116 (e.g., text, images, and/or video) for display at XR device 104. XR device 104 may display XR content 116 to user 102 (e.g., within a field of view 110 of user 102). In some aspects, XR content 116 may be based on the object of interest. For example, XR content 116 may be an altered version of object 114. As another example, XR content 116 may appear to interact with object 114. For example, object 114 may be a tree and XR content 116 may include a monkey climbing the tree.

In some aspects, XR device 104 may display XR content 116 in relation to the view of user 102 of the object of interest. For example, XR device 104 may overlay XR content 116 onto object 114 in field of view 110. In any case, XR device 104 may overlay XR content 116 (whether related to object 114 or not) onto the view of user 102 of scene 112. XR device 104 may anchor XR content 116 to object 114, for example, such that as user 102 moves their head (e.g., changing field of view 110), XR content 116 remains in the line of sight between the eyes of user 102 and object 114. To do this, XR device 104 may track a pose of XR device 104 (e.g., based on movement data from one or more inertial measurement units (IMUs) of XR device 104.

In a “see-through” configuration, XR device 104 may include a transparent surface (e.g., optical glass) such that XR content 116 may be displayed on (e.g., by being projected onto) the transparent surface to overlay the view of user 102 of scene 112 as viewed through the transparent surface. In a “pass-through” configuration or a “video see-through” (VST) configuration, XR device 104 may include a scene-facing camera that may capture images of scene 112. XR device 104 may display images or video of scene 112, as captured by the scene-facing camera, and XR content 116 overlaid on the images or video of scene 112.

In various examples, XR device 104 may be, or may include, a head-mounted device (HMD), a virtual reality headset, and/or smart glasses. XR device 104 may include one or more cameras, including scene-facing cameras and/or user-facing cameras, a graphics processing unit (GPU), one or more sensors (e.g., such as one or more inertial measurement units (IMUs), image sensors, and/or microphones), one or more communication units (e.g., wireless communication units), and/or one or more output devices (e.g., such as speakers, headphones, displays, and/or smart glass).

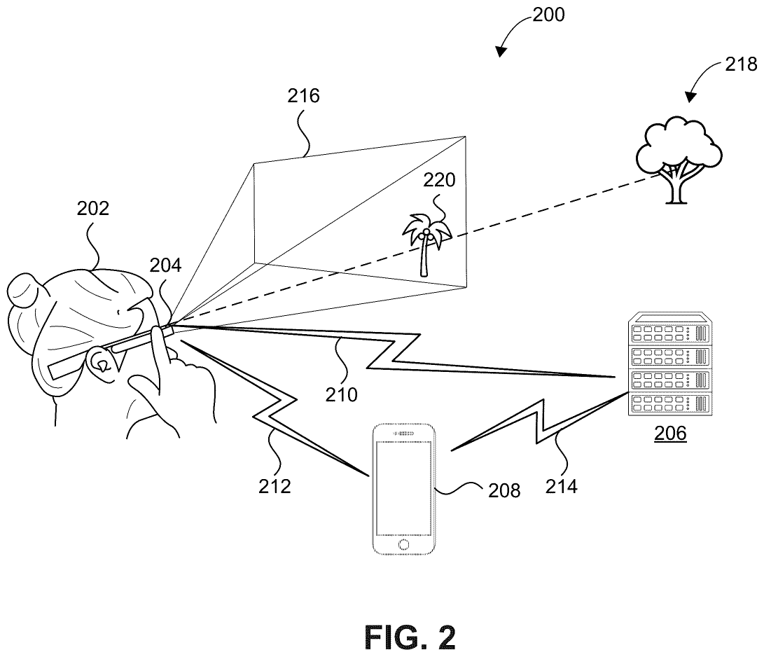

FIG. 2 is a diagram illustrating an example extended reality (XR) system 200, according to aspects of the disclosure. In some aspects, an XR system may be, or may include, two or more devices. The two or more devices of XR system 200 may perform the operations described with regard to XR system 100 of FIG. 1.

For example, XR system 200 includes a display device 204 and a processing device 206. In some aspects, display device 204 and processing device 206 may implement a communication link 210 between display device 204 and processing device 206. Communication link 210 may be a wireless connection according to any suitable wireless protocol, such as, a broadband-cellular-network protocol, for example, a fifth generation (5G) wireless cellular protocol.

In other aspects, XR system 200 may include a companion device 208. Display device 204 and companion device 208 and may implement a communication link 212 between display device 204 and companion device 208 and companion device 208 and processing device 206 may implement a communication link 214 between companion device 208 and processing device 206. Communication link 212 may be a wireless connection according to any suitable wireless protocol, such as, for example, Institute of Electrical and Electronics Engineers (IEEE) 802.11 (Wi-Fi), IEEE 802.15, or Bluetooth®. Communication link 214 may be a wireless connection according to any suitable wireless protocol, such as, a broadband-cellular-network protocol, for example, a fifth generation (5G) wireless cellular protocol.

Display device 204, processing device 206, and/or companion device 208 may collectively implement as examples, image-capture, object-detection, object-tracking, gaze-tracking, view-tracking, localization, pose-tracking, content-generation, content-rendering, computational, communicational, and/or display aspects of XR. For example, display device 204 may implement image-capture, gaze-tracking, view-tracking, localization, pose-tracking, communicational, and/or display aspects of XR. Processing device 206 may implement object-detection, object-tracking, localization, content-generation, content-rendering, computational, and/or communicational, aspects of XR. Additionally or alternatively, companion device 208 may implement at least a portion of one or more of localization, pose-tracking, communicational, object-detection, object-tracking, localization, content-generation, content-rendering, and/or computational aspects of XR.

For example, display device 204 may capture and/or generate data, such as image data (e.g., from user-facing cameras and/or scene-facing cameras) and/or motion data (from an inertial measurement unit (IMU)). Display device 204 may provide the data to processing device 206, for example, through communication link 210 or through communication link 212, companion device 208, and communication link 214.

Processing device 206 may process the data and/or other data (e.g., data received from another source or data stored at processing device 206). For example, processing device 206 may detect, recognize, and/or track objects in a scene 218 based on the images of the scene 218. Further, processing device 206 may generate (or obtain) XR content 220 to be rendered for display at display device 204. Processing device 206 may render XR content 220 to be appropriate for display at display device 204 (e.g., based on a pose of display device 204). Processing device 206 may provide rendered XR content 220 to display device 204 through communication link 210 (or communication link 214, companion device 208, and communication link 212) and display device 204 may display XR content 220 in field of view 216 of user 202.

In various examples, display device 204 may be, or may include, a head-mounted display (HMD), a virtual reality headset, and/or smart glasses. Display device 204 may include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, headphones, displays, and/or smart glass).

Processing device 206 may be, or may include, for example, a server computer (e.g., an edge or cloud-based server, a personal computer acting as a server device, or a mobile device acting as a server device). Processing device 206 may be configured to store virtual content and/or perform operations related to rendering the virtual content as image data suitable for providing to display device 204 for display.

Companion device 208 may be, or may include, a smartphone, laptop, tablet computer, personal computer, gaming system, any other computing device and/or a combination thereof.

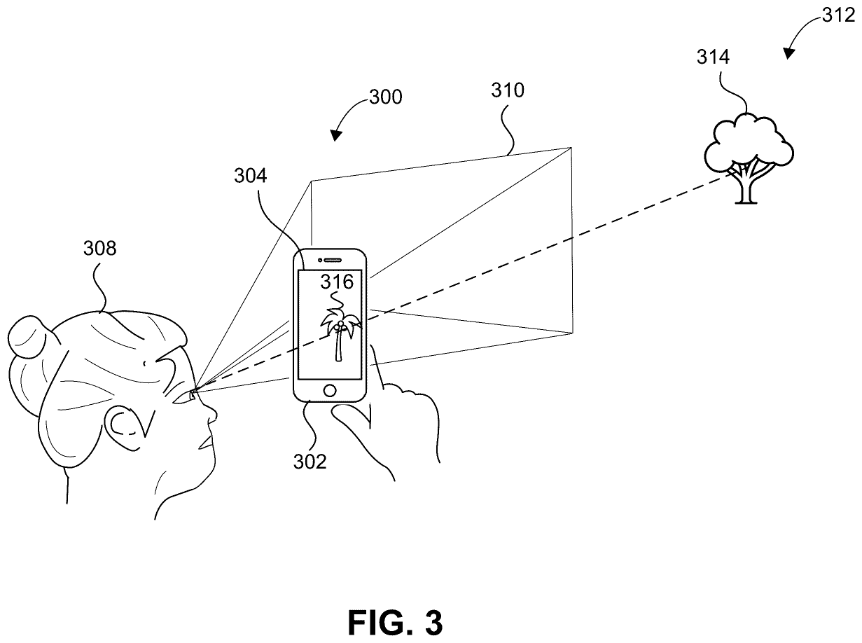

FIG. 3 is a diagram illustrating an example extended-reality (XR) system 300, according to aspects of the disclosure. As shown, XR system 300 includes an XR device 302 including a display 304. In some cases, XR device 302 may implement, as examples, image-capture, object-detection, object-tracking, gaze-tracking, view-tracking, localization, pose-tracking, content-generation, content-rendering, computational, communicational, and/or display aspects of XR.

For example, XR device 302 may include one or more scene-facing cameras that may capture images of a scene 312 in which a user 308 uses XR device 302. XR device 302 may detect objects (e.g., object 314) in scene 312 based on the images of scene 312. In some aspects, XR device 302 may include one or more user-facing cameras that may capture images of eyes of user 308. XR device 302 may determine a gaze of user 308 and/or a field of view 310 of user 308 based on the images of user 102. In some aspects, XR device 302 may determine an object of interest (e.g., object 314) in scene 312 (e.g., based on the gaze of user 308, based on object recognition, and/or based on a received indication regarding object 314). XR device 302 may obtain and/or render XR content 316 (e.g., text, images, and/or video) for display at display 304. XR device 302 may display XR content 316 to user 308 (e.g., within a field of view 310 of user 308). In some aspects, XR device 302 may determine a position of display 304 relative to field of view 310 of user 308 and scene 312. XR device 302 may track the pose of XR device 302 relative to user 308, field of view 310, and scene 312 such that XR content 316 aligns in field of view 310 of user 308 with scene 312. In some aspects, XR device 302 may capture images at a scene-facing camera and display the images at display 304 (e.g., without tracking field of view 310). XR device 302 may overlay XR content 316 onto the images captured by the scene-facing camera and displayed at display 304.

In some aspects, XR content 316 may be based on the object of interest. For example, XR content 316 may be an altered version of object 314. In some aspects, XR device 302 may display XR content 316 in relation to the view of user 308 of the object of interest. For example, XR device 302 may overlay XR content 316 onto object 314 in field of view 310. In any case, XR device 302 may overlay XR content 316 (whether related to object 314 or not) onto the view of user 308 of scene 312.

XR device 302 may operate in in a “pass-through” configuration or a “video see-through” configuration. For example, XR device 302 may include a scene-facing camera that may capture images of the scene of user 308. XR device 302 may display images or video of the scene, as captured by the scene-facing camera, and overlay XR content 316 onto the images or video of the scene. XR device 302 may display the information to be viewed by user 308 in field of view 310 of user 308. In a “see-through” configuration, XR device 302 may include a transparent surface (e.g., optical glass) such that information may be displayed on the transparent surface to overlay the information onto the scene as viewed through the transparent surface.

XR device 302 and/or display 304 may be, or may include, a handheld device, a smartphone, a tablet, or another computing device with a display. XR device 302 include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, display, and/or smart glass).

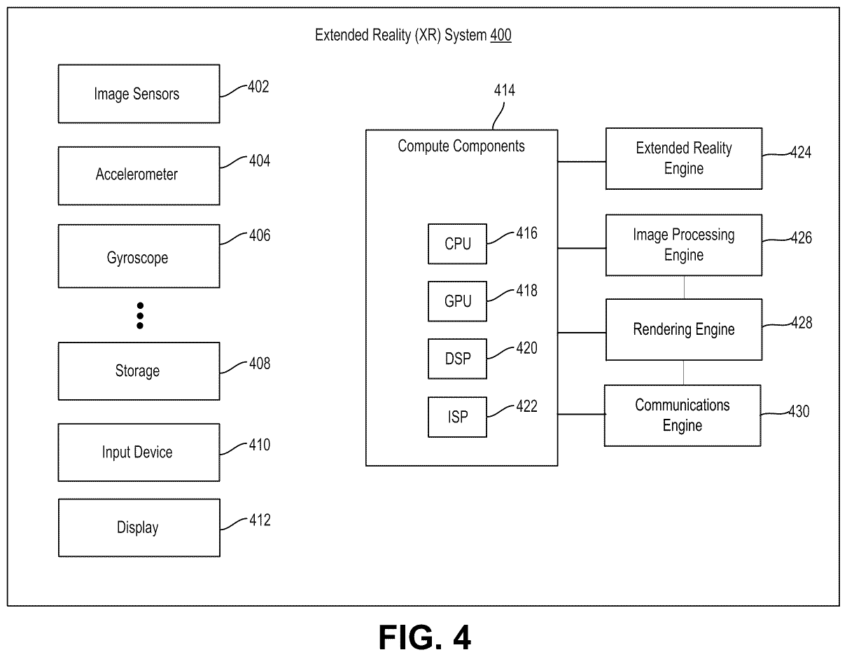

FIG. 4 is a diagram illustrating an architecture of an example extended reality (XR) system 400, in accordance with some aspects of the disclosure. XR system 400 may execute XR applications and implement XR operations. XR system 400 may be an example of, or be included in, any of XR device 104 of FIG. 1, display device 204 and/or companion device 208 of FIG. 2, and/or XR device 302 of FIG. 3.

In this illustrative example, XR system 400 includes one or more image sensors 402, an accelerometer 404, a gyroscope 406, storage 408, an input device 410, a display 412, Compute components 414, an XR engine 426, an image processing engine 428, a rendering engine 430, and a communications engine 432. It should be noted that the components 402-432 shown in FIG. 4 are non-limiting examples provided for illustrative and explanation purposes, and other examples may include more, fewer, or different components than those shown in FIG. 4. For example, in some cases, XR system 400 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 4. While various components of XR system 400, such as image sensor 402, may be referenced in the singular form herein, it should be understood that XR system 400 may include multiple of any component discussed herein (e.g., multiple image sensors 402).

Display 412 may be, or may include, a glass, a screen, a lens, a projector, and/or other display mechanism that allows a user to see the real-world environment and also allows XR content to be overlaid, overlapped, blended with, or otherwise displayed thereon.

XR system 400 may include, or may be in communication with, (wired or wirelessly) an input device 410. Input device 410 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 402 may capture images that may be processed for interpreting gesture commands.

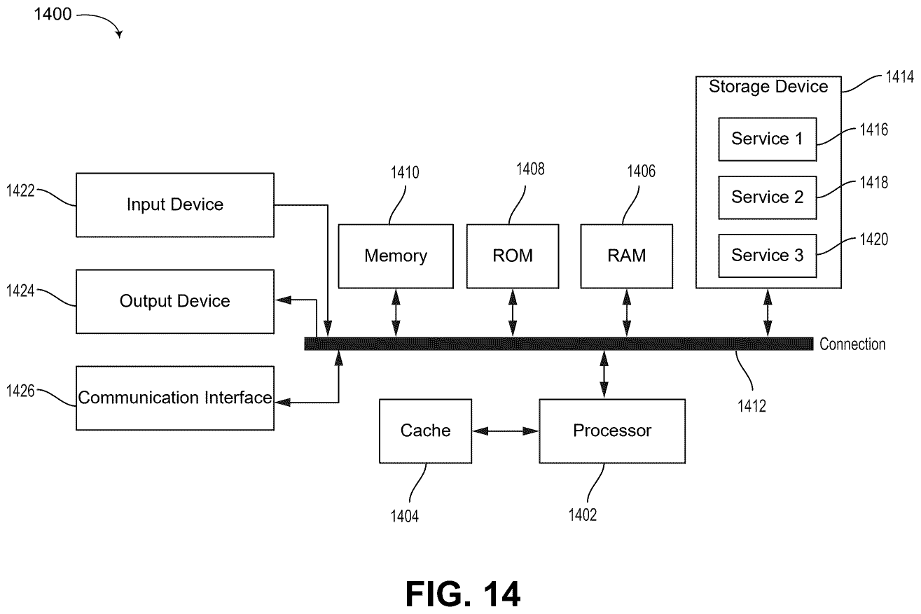

XR system 400 may also communicate with one or more other electronic devices (wired or wirelessly). For example, communications engine 432 may be configured to manage connections and communicate with one or more electronic devices. In some cases, communications engine 432 may correspond to communication interface 1426 of FIG. 14.

In some implementations, image sensors 402, accelerometer 404, gyroscope 406, storage 408, display 412, compute components 414, XR engine 426, image processing engine 428, and rendering engine 430 may be part of the same computing device. For example, in some cases, image sensors 402, accelerometer 404, gyroscope 406, storage 408, display 412, compute components 414, XR engine 426, image processing engine 428, and rendering engine 430 may be integrated into an HMD, extended reality glasses, smartphone, laptop, tablet computer, gaming system, and/or any other computing device. However, in some implementations, image sensors 402, accelerometer 404, gyroscope 406, storage 408, display 412, compute components 414, XR engine 426, image processing engine 428, and rendering engine 430 may be part of two or more separate computing devices. For instance, in some cases, some of the components 402-432 may be part of, or implemented by, one computing device and the remaining components may be part of, or implemented by, one or more other computing devices. For example, such as in a split perception XR system, XR system 400 may include a first device (e.g., an HMD), including display 412, image sensor 402, accelerometer 404, gyroscope 406, and/or one or more compute components 414. XR system 400 may also include a second device including additional compute components 414 (e.g., implementing XR engine 426, image processing engine 428, rendering engine 430, and/or communications engine 432). In such an example, the second device may generate virtual content based on information or data (e.g., images, sensor data such as measurements from accelerometer 404 and gyroscope 406) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 408 may be any storage device(s) for storing data. Moreover, storage 408 may store data from any of the components of XR system 400. For example, storage 408 may store data from image sensor 402 (e.g., image or video data), data from accelerometer 404 (e.g., measurements), data from gyroscope 406 (e.g., measurements), data from compute components 414 (e.g., processing parameters, preferences, virtual content, rendering content, scene maps, tracking and localization data, object detection data, privacy data, XR application data, face recognition data, occlusion data, etc.), data from XR engine 426, data from image processing engine 428, and/or data from rendering engine 430 (e.g., output frames). In some examples, storage 408 may include a buffer for storing frames for processing by compute components 414.

Compute components 414 may be, or may include, a central processing unit (CPU) 416, a graphics processing unit (GPU) 418, a digital signal processor (DSP) 420, an image signal processor (ISP) 422, a neural processing unit (NPU) 424, which may implement one or more trained neural networks, and/or other processors. Compute components 414 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 414 may implement (e.g., control, operate, etc.) XR engine 426, image processing engine 428, and rendering engine 430. In other examples, compute components 414 may also implement one or more other processing engines.

Image sensor 402 may include any image and/or video sensors or capturing devices. In some examples, image sensor 402 may be part of a multiple-camera assembly, such as a dual-camera assembly. Image sensor 402 may capture image and/or video content (e.g., raw image and/or video data), which may then be processed by compute components 414, XR engine 426, image processing engine 428, and/or rendering engine 430 as described herein.

In some examples, image sensor 402 may capture image data and may generate images (also referred to as frames) based on the image data and/or may provide the image data or frames to XR engine 426, image processing engine 428, and/or rendering engine 430 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 402 (and/or other camera of XR system 400) may be configured to also capture depth information. For example, in some implementations, image sensor 402 (and/or other camera) may include an RGB-depth (RGB-D) camera. In some cases, XR system 400 may include one or more depth sensors (not shown) that are separate from image sensor 402 (and/or other camera) and that may capture depth information. For instance, such a depth sensor may obtain depth information independently from image sensor 402. In some examples, a depth sensor may be physically installed in the same general location or position as image sensor 402 but may operate at a different frequency or frame rate from image sensor 402. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 400 may also include other sensors in its one or more sensors. The one or more sensors may include one or more accelerometers (e.g., accelerometer 404), one or more gyroscopes (e.g., gyroscope 406), and/or other sensors. The one or more sensors may provide velocity, orientation, and/or other position-related information to compute components 414. For example, accelerometer 404 may detect acceleration by XR system 400 and may generate acceleration measurements based on the detected acceleration. In some cases, accelerometer 404 may provide one or more translational vectors (e.g., up/down, left/right, forward/back) that may be used for determining a position or pose of XR system 400. Gyroscope 406 may detect and measure the orientation and angular velocity of XR system 400. For example, gyroscope 406 may be used to measure the pitch, roll, and yaw of XR system 400. In some cases, gyroscope 406 may provide one or more rotational vectors (e.g., pitch, yaw, roll). In some examples, image sensor 402 and/or XR engine 426 may use measurements obtained by accelerometer 404 (e.g., one or more translational vectors) and/or gyroscope 406 (e.g., one or more rotational vectors) to calculate the pose of XR system 400. As previously noted, in other examples, XR system 400 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 400, using a combination of one or more accelerometers, one or more gyroscopes, and/or one or more magnetometers. In some examples, the one or more sensors may output measured information associated with the capture of an image captured by image sensor 402 (and/or other camera of XR system 400) and/or depth information obtained using one or more depth sensors of XR system 400.

The output of one or more sensors (e.g., accelerometer 404, gyroscope 406, one or more IMUs, and/or other sensors) can be used by XR engine 426 to determine a pose of XR system 400 (also referred to as the head pose) and/or the pose of image sensor 402 (or other camera of XR system 400). In some cases, the pose of XR system 400 and the pose of image sensor 402 (or other camera) can be the same. The pose of image sensor 402 refers to the position and orientation of image sensor 402 relative to a frame of reference (e.g., with respect to a field of view 110 of FIG. 1). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g., roll, pitch, and yaw relative to the same frame of reference). In some implementations, the camera pose can be determined for 3-Degrees of Freedom (3DoF), which refers to the three angular components (e.g., roll, pitch, and yaw).

In some cases, a device tracker (not shown) can use the measurements from the one or more sensors and image data from image sensor 402 to track a pose (e.g., a 6DoF pose) of XR system 400. For example, the device tracker can fuse visual data (e.g., using a visual tracking solution) from the image data with inertial data from the measurements to determine a position and motion of XR system 400 relative to the physical world (e.g., the scene) and a map of the physical world. As described below, in some examples, when tracking the pose of XR system 400, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 400 within the scene and the 3D map of the scene, etc. The 3D map can provide a digital representation of a scene in the real/physical world. In some examples, the 3D map can anchor position-based objects and/or content to real-world coordinates and/or objects. XR system 400 can use a mapped scene (e.g., a scene in the physical world represented by, and/or associated with, a 3D map) to merge the physical and virtual worlds and/or merge virtual content or objects with the physical environment.

In some aspects, the pose of image sensor 402 and/or XR system 400 as a whole can be determined and/or tracked by compute components 414 using a visual tracking solution based on images captured by image sensor 402 (and/or other camera of XR system 400). For instance, in some examples, compute components 414 can perform tracking using computer vision-based tracking, model-based tracking, and/or simultaneous localization and mapping (SLAM) techniques. For instance, compute components 414 can perform SLAM or can be in communication (wired or wireless) with a SLAM system (not shown). SLAM refers to a class of techniques where a map of an environment (e.g., a map of an environment being modeled by XR system 400) is created while simultaneously tracking the pose of a camera (e.g., image sensor 402) and/or XR system 400 relative to that map. The map can be referred to as a SLAM map and can be three-dimensional (3D). The SLAM techniques can be performed using color or grayscale image data captured by image sensor 402 (and/or other camera of XR system 400) and can be used to generate estimates of 6DoF pose measurements of image sensor 402 and/or XR system 400. Such a SLAM technique configured to perform 6DoF tracking can be referred to as 6DoF SLAM. In some cases, the output of the one or more sensors (e.g., accelerometer 404, gyroscope 406, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 402 (and/or other camera) to the SLAM map. For example, 6DoF SLAM can use feature point associations from an input image to determine the pose (position and orientation) of the image sensor 402 and/or XR system 400 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 402 and/or the XR system 400 can be determined by projecting features from the 3D SLAM map into an image or video frame and updating the camera pose from verified 2D-3D correspondences.

In one illustrative example, the compute components 414 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 414 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 400 can also track the hand and/or fingers of the user to allow the user to interact with and/or control virtual content in a virtual environment. For example, the XR system 400 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

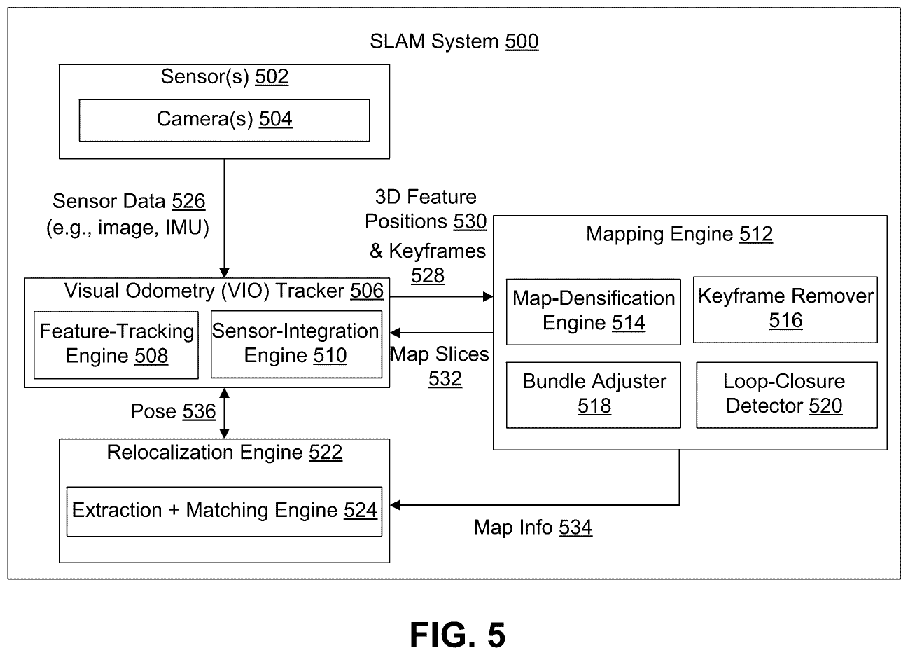

FIG. 5 is a block diagram illustrating an architecture of a simultaneous localization and mapping (SLAM) system 500, according to various aspects of the present disclosure. In some aspects, SLAM system 500 can be, or can include, a wireless communication device, a mobile device or handset (e.g., a mobile telephone or so-called “smart phone” or other mobile device), a wearable device, a personal computer, a laptop computer, a server computer, a portable video game console, a portable media player, a camera device, a manned or unmanned ground vehicle, a manned or unmanned aerial vehicle, a manned or unmanned aquatic vehicle, a manned or unmanned underwater vehicle, a manned or unmanned vehicle, an autonomous vehicle, a vehicle, a computing system of a vehicle, a robot, another device, or any combination thereof.

SLAM system 500 of FIG. 5 includes, or is coupled to, one or more sensor(s) 502. Sensor(s) 502 can include one or more camera(s) 504. Each of camera(s) 504 may be responsive to light from a particular spectrum of light. The spectrum of light may be a subset of the electromagnetic (EM) spectrum. For example, each of camera(s) 504 may be a visible light (VL) camera responsive to a VL spectrum, an infrared (IR) camera responsive to an IR spectrum, an ultraviolet (UV) camera responsive to a UV spectrum, a camera responsive to light from another spectrum of light from another portion of the electromagnetic spectrum, or a some combination thereof.

Sensor(s) 502 can include one or more other types of sensors other than camera(s) 504, such as one or more of each of: accelerometers, gyroscopes, magnetometers, inertial measurement units (IMUs), altimeters, barometers, thermometers, radio detection and ranging (RADAR) sensors, light detection and ranging (LIDAR) sensors, sound navigation and ranging (SONAR) sensors, sound detection and ranging (SODAR) sensors, global navigation satellite system (GNSS) receivers, global positioning system (GPS) receivers, BeiDou navigation satellite system (BDS) receivers, Galileo receivers, Globalnaya Navigazionnaya Sputnikovaya Sistema (GLONASS) receivers, Navigation Indian Constellation (NavIC) receivers, Quasi-Zenith Satellite System (QZSS) receivers, Wi-Fi positioning system (WPS) receivers, cellular network positioning system receivers, Bluetooth® beacon positioning receivers, short-range wireless beacon positioning receivers, personal area network (PAN) positioning receivers, wide area network (WAN) positioning receivers, wireless local area network (WLAN) positioning receivers, other types of positioning receivers, other types of sensors discussed herein, or combinations thereof.

SLAM system 500 includes a visual-inertial odometry (VIO) tracker 506. The term visual-inertial odometry may also be referred to herein as visual odometry. VIO tracker 506 receives sensor data 526 from sensor(s) 502. For instance, sensor data 526 can include one or more images captured by camera(s) 504. Sensor data 526 can include other types of sensor data from camera(s) 504, such as data from any of the types of camera(s) 504 listed herein. For instance, sensor data 526 can include inertial measurement unit (IMU) data from one or more IMUs of camera(s) 504.

Upon receipt of sensor data 526 from sensor(s) 502, VIO tracker 506 performs feature detection, extraction, and/or tracking using a feature-tracking engine 508 of VIO tracker 506. For instance, where sensor data 526 includes one or more images captured by camera(s) 504 of SLAM system 500, VIO tracker 506 can identify, detect, and/or extract features in each image. Features may include visually distinctive points in an image, such as portions of the image depicting edges and/or corners. VIO tracker 506 can receive sensor data 526 periodically and/or continually from sensor(s) 502, for instance by continuing to receive more images from camera(s) 504 as camera(s) 504 capture a video, where the images are video frames of the video. VIO tracker 506 can generate descriptors for the features. Feature descriptors can be generated at least in part by generating a description of the feature as depicted in a local image patch extracted around the feature. In some examples, a feature descriptor can describe a feature as a collection of one or more feature vectors. VIO tracker 506, in some cases with mapping engine 512 and/or relocalization engine 522, can associate the plurality of features with a map of the environment based on such feature descriptors. Feature-tracking engine 508 of VIO tracker 506 can perform feature tracking by recognizing features in each image that VIO tracker 506 already previously recognized in one or more previous images, in some cases based on identifying features with matching feature descriptors in different images. Feature-tracking engine 508 can track changes in one or more positions at which the feature is depicted in each of the different images. For example, the feature extraction engine can detect a particular corner of a room depicted in a left side of a first image captured by a first camera of camera(s) 504. Feature-tracking engine 508 can detect the same feature (e.g., the same particular corner of the same room) depicted in a right side of a second image captured by the first camera. Feature-tracking engine 508 can recognize that the features detected in the first image and the second image are two depictions of the same feature (e.g., the same particular corner of the same room), and that the feature appears in two different positions in the two images. VIO tracker 506 can determine, based on the same feature appearing on the left side of the first image and on the right side of the second image that the first camera has moved, for example if the feature (e.g., the particular corner of the room) depicts a static portion of the environment.

VIO tracker 506 can include a sensor-integration engine 510. Sensor-integration engine 510 can use sensor data from other types of sensor(s) 502 (other than camera(s) 504) to determine information that can be used by feature-tracking engine 508 when performing the feature tracking. For example, sensor-integration engine 510 can receive IMU data (e.g., which can be included as part of sensor data 526) from an IMU of sensor(s) 502. Sensor-integration engine 510 can determine, based on the IMU data in sensor data 526, that SLAM system 500 has rotated 15 degrees in a clockwise direction from acquisition or capture of a first image and capture to acquisition or capture of the second image by a first camera of camera(s) 504. Based on this determination, sensor-integration engine 510 can identify that a feature depicted at a first position in the first image is expected to appear at a second position in the second image, and that the second position is expected to be located to the left of the first position by a predetermined distance (e.g., a predetermined number of pixels, inches, centimeters, millimeters, or another distance metric). Feature-tracking engine 508 can take this expectation into consideration in tracking features between the first image and the second image.

Based on the feature tracking by feature-tracking engine 508 and/or the sensor integration by sensor-integration engine 510, VIO tracker 506 can determine a 3D feature positions 530 of a particular feature. 3D feature positions 530 can include one or more 3D feature positions and can also be referred to as 3D feature points. 3D feature positions 530 can be a set of coordinates along three different axes that are perpendicular to one another, such as an X coordinate along an X axis (e.g., in a horizontal direction), a Y coordinate along a Y axis (e.g., in a vertical direction) that is perpendicular to the X axis, and a Z coordinate along a Z axis (e.g., in a depth direction) that is perpendicular to both the X axis and the Y axis. VIO tracker 506 can also determine one or more keyframes 528 (referred to hereinafter as keyframes 528) corresponding to the particular feature. A keyframe (from one or more keyframes 528) corresponding to a particular feature may be an image in which the particular feature is clearly depicted. In some examples, a keyframe (from the one or more keyframes 528) corresponding to a particular feature may be an image in which the particular feature is clearly depicted. In some examples, a keyframe corresponding to a particular feature may be an image that reduces uncertainty in 3D feature positions 530 of the particular feature when considered by feature-tracking engine 508 and/or sensor-integration engine 510 for determination of 3D feature positions 530. In some examples, a keyframe corresponding to a particular feature also includes data associated with pose 536 of SLAM system 500 and/or camera(s) 504 during capture of the keyframe. In some examples, VIO tracker 506 can send 3D feature positions 530 and/or keyframes 528 corresponding to one or more features to mapping engine 512. In some examples, VIO tracker 506 can receive map slices 532 from mapping engine 512. VIO tracker 506 can feature information within map slices 532 for feature tracking using feature-tracking engine 508.

Based on the feature tracking by feature-tracking engine 508 and/or the sensor integration by sensor-integration engine 510, VIO tracker 506 can determine a pose 536 of SLAM system 500 and/or of camera(s) 504 during capture of each of the images in sensor data 526. Pose 536 can include a location of SLAM system 500 and/or of camera(s) 504 in 3D space, such as a set of coordinates along three different axes that are perpendicular to one another (e.g., an X coordinate, a Y coordinate, and a Z coordinate). Pose 536 can include an orientation of SLAM system 500 and/or of camera(s) 504 in 3D space, such as pitch, roll, yaw, or some combination thereof. In some examples, VIO tracker 506 can send pose 536 to relocalization engine 522. In some examples, VIO tracker 506 can receive pose 536 from relocalization engine 522.

SLAM system 500 also includes a mapping engine 512. Mapping engine 512 generates a 3D map of the environment based on 3D feature positions 530 and/or keyframes 528 received from VIO tracker 506. Mapping engine 512 can include a map-densification engine 514, a keyframe remover 516, a bundle adjuster 518, and/or a loop-closure detector 520. Map-densification engine 514 can perform map densification, in some examples, increase the quantity and/or density of 3D coordinates describing the map geometry. Keyframe remover 516 can remove keyframes, and/or in some cases add keyframes. In some examples, keyframe remover 516 can remove keyframes 528 corresponding to a region of the map that is to be updated and/or whose corresponding confidence values are low. Bundle adjuster 518 can, in some examples, refine the 3D coordinates describing the scene geometry, parameters of relative motion, and/or optical characteristics of the image sensor used to generate the frames, according to an optimality criterion involving the corresponding image projections of all points. Loop-closure detector 520 can recognize when SLAM system 500 has returned to a previously mapped region and can use such information to update a map slice and/or reduce the uncertainty in certain 3D feature points or other points in the map geometry. Mapping engine 512 can output map slices 532 to VIO tracker 506. Map slices 532 can represent 3D portions or subsets of the map. Map slices 532 can include map slices 532 that represent new, previously-unmapped areas of the map. Map slices 532 can include map slices 532 that represent updates (or modifications or revisions) to previously-mapped areas of the map. Mapping engine 512 can output map information 534 to relocalization engine 522. Map information 534 can include at least a portion of the map generated by mapping engine 512. Map information 534 can include one or more 3D points making up the geometry of the map, such as one or more 3D feature positions 530. Map information 534 can include one or more keyframes 528 corresponding to certain features and certain 3D feature positions 530.

SLAM system 500 also includes a relocalization engine 522. Relocalization engine 522 can perform relocalization, for instance when VIO tracker 506 fail to recognize more than a threshold number of features in an image, and/or VIO tracker 506 loses track of pose 536 of SLAM system 500 within the map generated by mapping engine 512. Relocalization engine 522 can perform relocalization by performing extraction and matching using an extraction and matching engine 524. For instance, extraction and matching engine 524 can by extract features from an image captured by camera(s) 504 of SLAM system 500 while SLAM system 500 is at a current pose 536, and can match the extracted features to features depicted in different keyframes 528, identified by 3D feature positions 530, and/or identified in map information 534. By matching these extracted features to the previously-identified features, relocalization engine 522 can identify that pose 536 of SLAM system 500 is a pose 536 at which the previously-identified features are visible to camera(s) 504 of SLAM system 500, and is therefore similar to one or more previous poses 536 at which the previously-identified features were visible to camera(s) 504. In some cases, relocalization engine 522 can perform relocalization based on wide baseline mapping, or a distance between a current camera position and camera position at which feature was originally captured. Relocalization engine 522 can receive information for pose 536 from VIO tracker 506, for instance regarding one or more recent poses of SLAM system 500 and/or camera(s) 504 which relocalization engine 522 can base its relocalization determination on. Once relocalization engine 522 relocates SLAM system 500 and/or camera(s) 504 and thus determines pose 536, relocalization engine 522 can output pose 536 to VIO tracker 506.

In some examples, VIO tracker 506 can modify the image in sensor data 526 before performing feature detection, extraction, and/or tracking on the modified image. For example, VIO tracker 506 can rescale and/or resample the image. In some examples, rescaling and/or resampling the image can include downscaling, downsampling, subscaling, and/or subsampling the image one or more times. In some examples, VIO tracker 506 modifying the image can include converting the image from color to greyscale, or from color to black and white, for instance by desaturating color in the image, stripping out certain color channel(s), decreasing color depth in the image, replacing colors in the image, or a combination thereof. In some examples, VIO tracker 506 modifying the image can include VIO tracker 506 masking certain regions of the image. Dynamic objects can include objects that can have a changed appearance between one image and another. For example, dynamic objects can be objects that move within the environment, such as people, vehicles, or animals. A dynamic object can be an object that have a changing appearance at different times, such as a display screen that may display different things at different times. A dynamic object can be an object that has a changing appearance based on the pose of camera(s) 504, such as a reflective surface, a prism, or a specular surface that reflects, refracts, and/or scatters light in different ways depending on the position of camera(s) 504 relative to the dynamic object. VIO tracker 506 can detect the dynamic objects using facial detection, facial recognition, facial tracking, object detection, object recognition, object tracking, or a combination thereof. VIO tracker 506 can detect the dynamic objects using one or more artificial intelligence algorithms, one or more trained machine learning models, one or more trained neural networks, or a combination thereof. VIO tracker 506 can mask one or more dynamic objects in the image by overlaying a mask over an area of the image that includes depiction(s) of the one or more dynamic objects. The mask can be an opaque color, such as black. The area can be a bounding box having a rectangular or other polygonal shape. The area can be determined on a pixel-by-pixel basis.

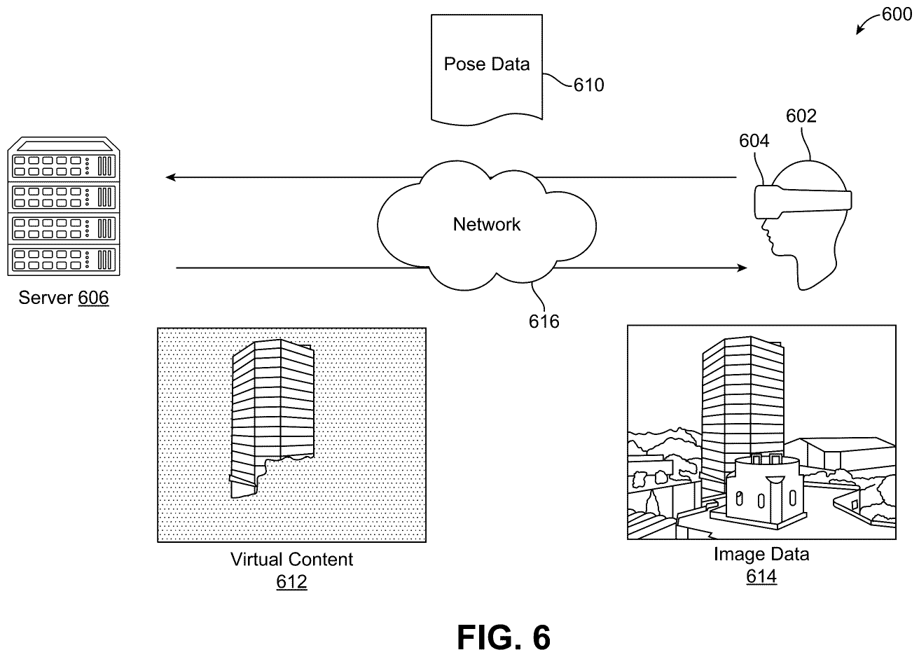

FIG. 6 is a block diagram illustrating an example system 600 for extended reality, according to various aspects of the present disclosure. In general, an XR device 604 of user 602 may determine pose data 610 and transmit pose data 610 to server 606 (e.g., via a network 616). Server 606 may determine virtual content 612 and render virtual content 612 based on pose data 610 as image data 614 and transmit image data 614 to XR device 604. XR device 604 may display image data 614 to user 602.

XR device 604 may be any suitable XR device. XR device 604 may be an example of XR device 104 of FIG. 1, display device 204 and/or companion device 208 of FIG. 2 and/or XR system 300 of FIG. 3, XR system 400 of FIG. 4. XR device 604 may implement AR or MR by displaying virtual content in a field of view of user 602 (e.g., as described with regard to FIG. 1, FIG. 2, and/or FIG. 3). XR device 604 may be, or may include, an HMD or a handheld device that may display virtual content in a field of view of user 602.

XR device 604 may determine pose data 610 which may be, or may include, a 6DoF pose of XR device 604 (e.g., based on inertial data from one or more IMUs of XR device 604 (e.g., including accelerometer 404 and/or gyroscope 406) and/or based on visual odometry, such as SLAM such as described with regard to SLAM system 500 of FIG. 5).

Server 606 may be any suitable computing device. Processing device 206 of FIG. 2 is an example of server 606. For example, server 606 may be, or may include, a remote computing device, such as a server computer at a remote location connected to user 602 via network 616.

Server 606 may generate image data 614 based on pose data 610. For example, server 606 may render image data 614 such that image data 614 may be displayed to user 602 in the field of view of user 602 such that virtual content 612 appears to be in the scene in field of view of user 602. For example, server 606 may render image data 614 such that virtual content 612 may appear anchored to a point in the scene such that as user 602 moves and/or reorients their head, virtual content 612 appears to stay anchored to the point. To anchor virtual content 612 in the scene, server 606 may generate image data 614 based on pose data 610.

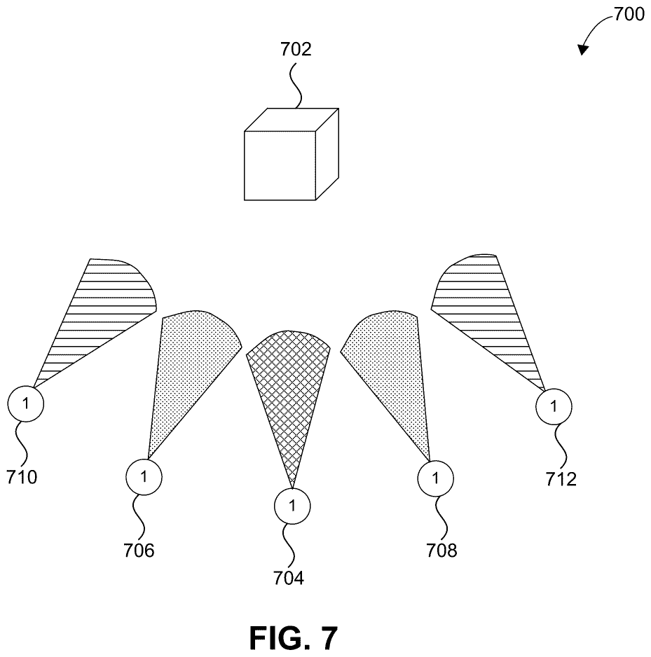

FIG. 7 is a diagram of a 3D space 700 including a virtual object 702 and representations of various poses (e.g., pose 704, pose 706, pose 708, pose 710, and pose 712) from which virtual object 702 may be viewed, according to various aspects of the present disclosure. The systems and techniques include pre-rendering virtual content based on a pose (e.g., a position and an orientation) of an XR device. For example, a server (e.g., server 606) (or the XR device) may render image data based on virtual object 702 from one or more of pose 704, pose 706, pose 708, pose 710, and/or pose 710 based on a probability associated with pose 704, pose 706, pose 708, pose 710, and/or pose 710.

For example, a user with an XR device who may be presented with virtual content (e.g., image data rendered based on virtual content). This image data may be pre-rendered at a server, which can reduce latency and conserve power of the XR device.

There is a trade-off between rendering image data at a server (e.g., server 606) as compared to rendering the image data at an XR device (e.g., XR device 604). For example, rendering image data at an XR device may be costly for the XR device in terms of computation time and/or power consumption whereas a server may be less power and/or computationally constrained than the XR device. However, rendering image data at a server may introduce a communication delay. For example, it may take time for to communicate a pose (e.g., pose data 610) of the XR device and to communicate the image data (e.g., image data 614).

The systems and techniques may determine the extent of virtual content to pre-render at a server (e.g., server 606) as compared to at an XR device (e.g., XR device 604) based on the virtual-content size, the virtual-content complexity, the desired latency of displaying the image data, and/or the current link quality (achievable data rate). For example, the systems and techniques may determine how much, which, and/or at what quality (e.g., resolution) to render image data based on the size of the virtual content, the complexity of the virtual content, the desired latency, and/or the current link quality.

For example, there may be several virtual objects associated with an environment. Additionally or alternatively, an environment may be associated with a virtual object that may be viewed from different perspectives or point-of-views (PoVs). For scalability and efficiency, the systems and techniques may determine a subset of the PoVs and/or virtual objects and prioritize the subset for pre-rendering.

Each of the PoVs may be assigned a probability or likelihood of occurrence. The probabilities may be based on a distance from a current pose of the XR device. For example, the XR device (e.g., XR device 604) may be at pose 704 relative to virtual object 702. Pose 704 may be assigned a high probability (e.g., 100%). Poses close to pose 704 (e.g., pose 706 and pose 708) may be assigned medium probabilities (e.g., 75%) and poses farther away from pose 704 (e.g., pose 710 and pose 712) may be assigned lower probabilities (e.g., 50%).

The systems and techniques may cause a server (e.g., server 606) to pre-render virtual content from different poses based on the probabilities of the poses. For example, the server may render image data of virtual object 702 from pose 704, pose 706, and pose 708 based on pose 704, pose 706, and pose 708 having probabilities that are above a probability or likelihood threshold (e.g., 60%). Alternatively, the server may render image data of virtual object 702 from pose 704, pose 706, and pose 708 based on pose 704, pose 706, and pose 708 based on the positions of pose 706 and pose 708 being within a threshold distance (e.g., 2 meters) from pose 704.

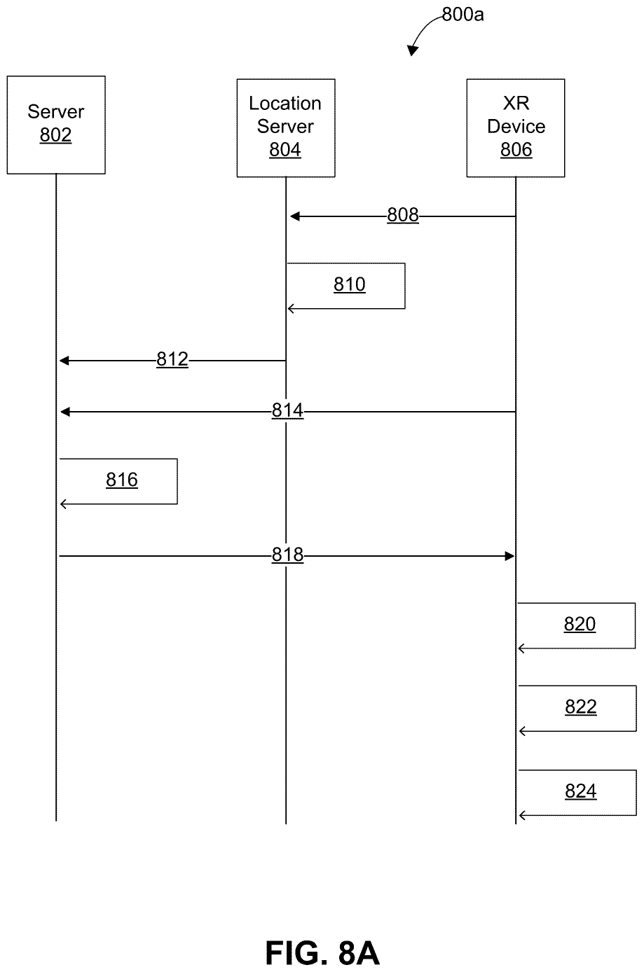

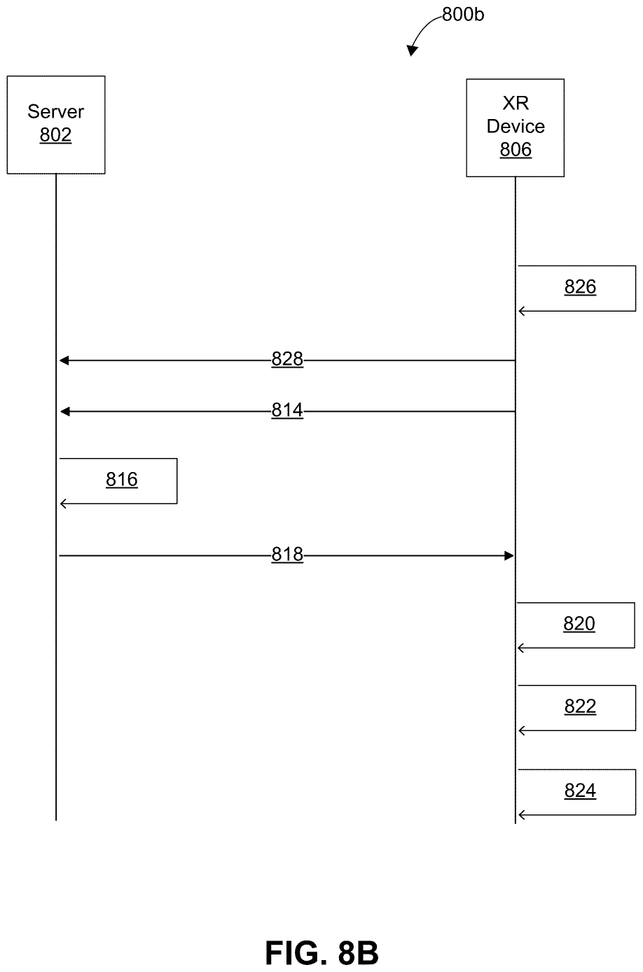

FIG. 8A includes a process diagram illustrating an example process 800a of rendering image data for XR, according to various aspects of the present disclosure. XR device 806 may be an example of XR device 604 of FIG. 6. Server 802 may be an example of server 606 of FIG. 6.

XR device 806 may include an IMU, a camera, one or more antennae, and/or a global-positioning system (GPS) module. At operation 808, XR device 806 may transmit movement, orientation, radio-frequency (RF) data, and/or location data (e.g., data from an IMU, image data, timing data from a GPS, and/or location data, for example, from a GPS module of XR device 806) to location server 804.

At operation 810, location server 804 may determine a pose (e.g., position and orientation) of XR device 806. In some aspects, location server 804 may be a computing device separate from server 802. In other aspects, location server 804 may be implemented in the same computing device as location server 804. location server 804 may conserve computational resources of XR device 806 by computing the pose of XR device 806 at location server 804. location server 804 may determine the pose of XR device 806 according to inertial-navigation techniques based on IMU data, according to visual-odometry techniques based on images captured by XR device 806, based on GPS data, and/or based on RF data measured by XR device 806.

At operation 812, location server 804 may provide pose data indicative of a pose of XR device 806 to server 802. At operation 814, XR device 806 may provide link-quality information (e.g., statistics) and/or rendering-capability information (e.g., statistics) to server 802. The link-quality information may be, or may include, a communication latency between XR device 806 and server 802 and/or a bandwidth for communications between server 802 and XR device 806. The rendering-capability information may describe an ability of XR device 806 to render image data based on virtual content.

Although operation 808, operation 810, and operation 812 and operation 814 are illustrated and described in order, operation 814 may occur any time before operation 816, for example, before operation 808, between operation 808 and operation 810, between operation 810 and operation 812, and/or at substantially the same time as any of operation 808, operation 810, or operation 812.

At operation 816, server 802 may render image data based on virtual content and the pose of XR device 806. In some aspects, server 802 may prerender image data for XR device 806.

For example, server 802 may determine multiple poses of XR device 806, for example, based on the pose data of XR device 806. XR device 806 may send pose data indicating that XR device 806 is in pose 704. Server 802 may determine pose 706, pose 708, pose 710, and pose 712 based on pose 704. Additionally, server 802 may determine a probability associated with each of pose 704, pose 706, pose 708, pose 710, and pose 712.

In some aspects, server 802 may render multiple images corresponding to multiple different poses. For example, server 802 may render image data representing virtual object 702 as viewed from pose 704, image data representing virtual object 702 as viewed from pose 706, and image data representing virtual object 702 as viewed from pose 706. Server 802 may render the image data as viewed from pose 704, pose 706, and pose 708 based on the probabilities associated with each of pose 704, pose 706, and pose 708 exceeding a probability threshold.

In rendering image data as viewed from pose 706 and pose 708, server 802 may be prerendering image data based on a probability that XR device 806 will view virtual object 702 from pose 706 and/or pose 708.

Pre-renderings under multiple hypotheses (e.g., predicted poses) may also be prioritized for sequential reporting based on their likelihood of occurrence. Additionally or alternatively, an ‘early termination’ criteria can also be imposed wherein XR device 806 sends an indication that some hypotheses will be less likely, based on which the server does not report those corresponding pre-rendered image data. Similarly, XR device 806 may explicitly provide the likelihood of occurrence based on its potential route or trajectory that will be taken.

Additionally or alternatively, server 802 determine the extent of virtual content to pre-render at server 802 based on the virtual-content size, the virtual-content complexity, the desired latency of displaying the image data (e.g., as indicated by link-quality information received at operation 814), and/or the current link quality (achievable data rate) (e.g., as indicated by link-quality information received at operation 814). For example, server 802 may determine how much, which, and/or at what quality (e.g., resolution) to render image data based on the size of the virtual content, the complexity of the virtual content, the desired latency, and/or the current link quality. For example, there may be several virtual objects associated with an environment. Additionally or alternatively, an environment may be associated with a virtual object that may be viewed from different perspectives or point-of-views (PoVs). For scalability and efficiency, server 802 may determine a subset of the PoVs and/or virtual objects and prioritize the subset for pre-rendering.

In some aspects, the terms “viewpoint,” “PoV,” “perspective,” and like terms may refer to a position relative and/or orientation of an object (e.g., an XR device) relative to an object (e.g., virtual or real) or scene. An XR device may have a pose (position and orientation). From the pose, the XR device may have a PoV of an object. In cases of virtual objects, the virtual objects may be associated (e.g., anchored) with respect to a point in a real-world scene. The XR device may have a PoV relative to the point in the real-world scene. That PoV may be the PoV of the XR device relative to the virtual object.

At operation 818, server 802 may transmit the image data to XR device 806. For example, server 802 may transmit the image data corresponding to the multiple poses to XR device 806.

At operation 820, XR device 806 may display one of the images received at operation 818. For example, XR device 806 may display an image corresponding to a pose of XR device 806.

In some aspects, server 802 may render the image data and generate conditions for displaying the image data. For example, in some cases, server 802 may render image data for immediate display. In other cases, server 802 may render image data for display in the future (e.g., 0.10 seconds in the future). In still other cases, server 802 may render image data for display when XR device 806 has a arrive at a pose for example, when XR device 806 has pose 706. Server 802 may provide conditions for when to display image data along with the image data.

At operation 822, XR device 806 may store one or more additional images received at operation 818. For example, XR device 806 may store images for poses that do not correspond to a current pose of XR device 806.

At operation 824, XR device 806 may display an image stored at operation 822. For example, XR device 806 may determine that XR device 806 has moved to a pose corresponding to a pose of one of the images stored at operation 822. Based on the current pose of XR device 806 matching the pose of a stored image, XR device 806 may display the stored image.

In some aspects, XR device 806 may render and display image data. For example, in cases in which a pose of XR device 806 does not match a pose predicted by server 802, XR device 806 may render image data based on virtual content. As an example, in cases in which server 802 determined not to render image data (e.g., based on latency, bandwidth, and/or size and/or complexity of the virtual content, XR device 806 may render the image data. In some aspects, server 802 may partially render the data (e.g., at a lower resolution) and XR device 806 may further render the image data (e.g., at a higher resolution).

FIG. 8B includes a process diagram illustrating an example process 800b of rendering image data for XR, according to various aspects of the present disclosure. Process 800b is substantially similar to process 800a except that in process 800b, operations of location server 804 are performed by XR device 806.

For example, in process 800a, XR device 806 transmits movement data to location server 804 and location server 804 determines the pose of XR device 806 and transmits the pose to 802. In process 800b, at operation 826, XR device 806 determines the pose of XR device 806 and at operation 828, XR device 806 transmits the pose of XR device 806 to server 802.

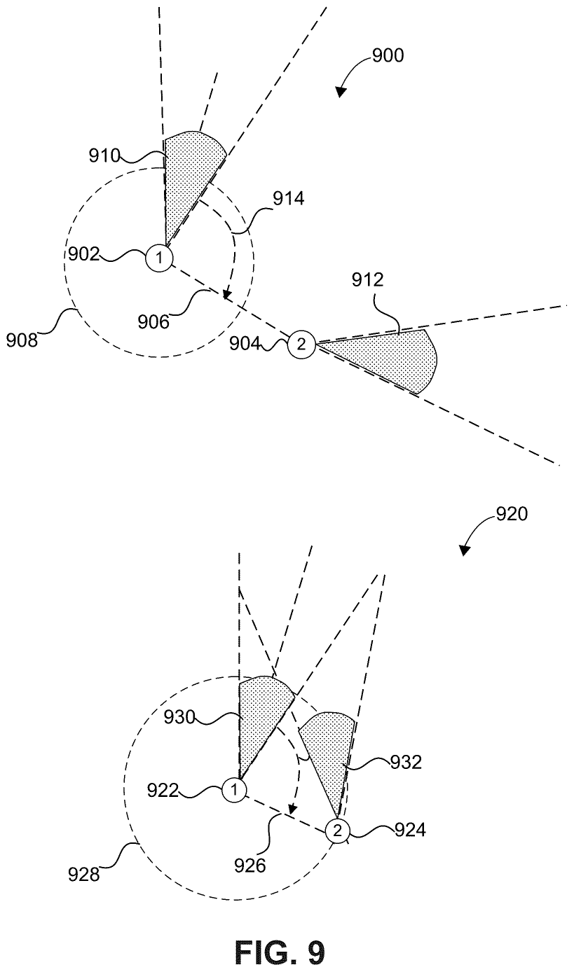

FIG. 9 includes two diagrams, each illustrating a respective scenario for the systems and techniques may determine to render or pre-render image data, according to various aspects of the present disclosure. For example, scenario 900 illustrates an XR device 902 and an XR device 904. XR device 904 is distance 906 from XR device 902 at an example angle of arrival (AoA) 914. According to various examples, the systems and techniques may determine to render, pre-render, or not render or pre-render image data based on virtual content and based on the satisfaction, or not, of one or more relative position criteria. For example, the systems and techniques may determine not to render or pre-render image data for one or both of XR device 902 and XR device 904 based on distance 906 exceeding a distance threshold 908. As another example, the systems and techniques may determine to not render or pre-render image data for one or both of XR device 902 and XR device 904 based on a rate at which distance 906 is changing (e.g., based on a user of XR device 904 walking away from XR device 902). As another example, the systems and techniques may determine not to render or pre-render image data for one or both of XR device 902 and XR device 904 based on AoA 914 being within or without an AoA threshold. As another example, the systems and techniques may determine not to render or pre-render image data for one or both of XR device 902 and XR device 904 based on an angle between field of view (FoV) 910 of XR device 902 and FoV 912 of XR device 904.

As another example, scenario 920 illustrates an XR device 922 and an XR device 924. XR device 924 is distance 926 from XR device 922 at an example AoA 934. According to various examples, the systems and techniques may determine to render, pre-render, or not render or pre-render image data based on virtual content and based on the satisfaction, or not, of one or more relative position criteria. For example, the systems and techniques may determine to render or pre-render image data for one or both of XR device 922 and XR device 924 based on distance 926 being within a distance threshold 928. As another example, the systems and techniques may determine to render or pre-render image data for one or both of XR device 922 and XR device 924 based on a rate at which distance 926 is changing (e.g., based on a user of XR device 924 walking toward XR device 922). As another example, the systems and techniques may determine to render or pre-render image data for one or both of XR device 922 and XR device 924 based on AoA 934 being within or without an AoA threshold. As another example, the systems and techniques may determine to render or pre-render image data for one or both of XR device 922 and XR device 924 based on an angle between, or overlap of, FoV 930 of XR device 922 and FoV 932 of XR device 924.

The range between XR devices typically changes slowly and is predictable. In addition to the relative range and speed, the direction in which users are moving (estimated using IMU and/or Angle-of-Arrival measurements) can also be used as a metric to determine whether content should be pre-rendered.

For example, as illustrated by scenario 900, two users (carrying XR devices) may move in different directions with potentially no overlap in their field-of-views (FoVs). In such a case (relative FoV within a threshold value), virtual content may not be pre-rendered.

However, as compared to the relative range, the relative direction can change much more dynamically. Hence, within a threshold relative range value, a subset of visual objects ‘A’ may be pre-rendered at the server, while another subset of visual objects ‘B’ may be rendered in real-time by the devices. Subset ‘A’ may be, or may include, high-quality, complex, or large-sized visual content that requires superior computing resources (e.g., computing resources available at the server) while subset ‘B’ may be, or may include, low-complexity visual objects that can be rendered by the AR devices themselves. Similarly, subset ‘A’ may be, or may include, content corresponding to high-likelihood poses, while subset ‘B’ comprises low-likelihood poses.

The XR devices may then display the image data based on their relative FoV. For instance, object ‘C’ is displayed when both users are looking towards the north and object ‘D’ may be displayed when both users are looking towards the southeast. These objects may belong to either subset ‘A’ or ‘B’.

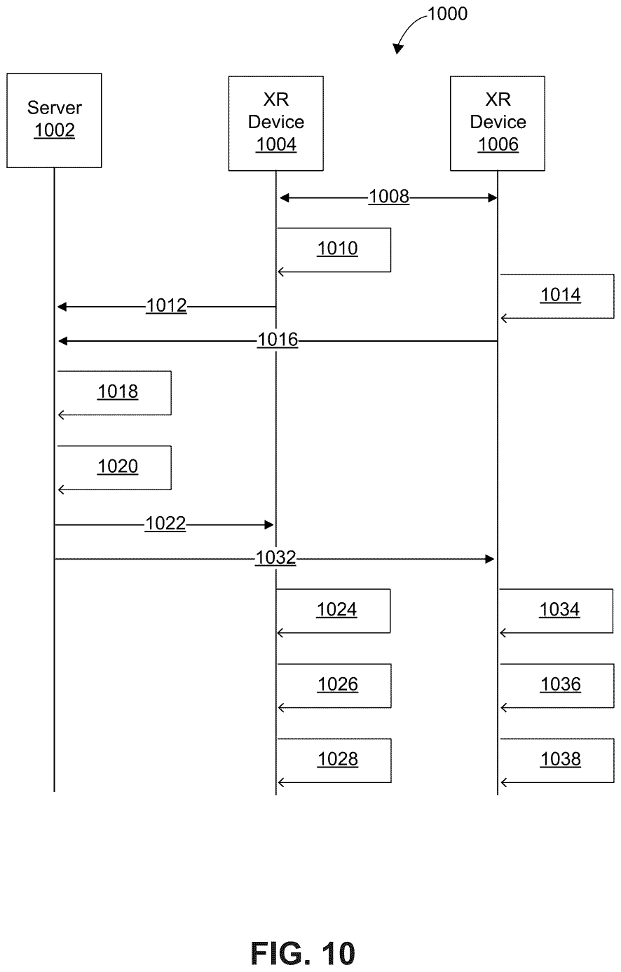

FIG. 10 includes a process diagram illustrating an example process 1000 of rendering image data for XR, according to various aspects of the present disclosure. XR device 1004 and XR device 1006 may be examples of XR device 604 of FIG. 6. Server 802 may be an example of server 606 of FIG. 6. Additionally, XR device 1004 and XR device 1006 may be positioned and oriented relative to one another. Further, XR device 1004 and XR device 1006 may move and/or reorient relative to one another, for example, as illustrated and described with regard to scenario 900 and scenario 920 of FIG. 9.

Operations 1008 through 1018 may include determining a relative position of XR device 1004 and XR device 1006 and/or determining whether the relative position of XR device 1004 and XR device 1006 satisfies a criteria, for example, as described with regard to FIG. 9. There are various ways in which the relative position may be determined.

For example, at operation 1008, XR device 1004 and XR device 1006 may exchange signals, for example, beacon signals. One or both of XR device 1004 and XR device 1006 may determine the relative position of XR device 1004 and XR device 1006 based on the signals (e.g., based on signal strength and/or angle of arrival). For example, at operation 1010, XR device 1004 may determine the position of XR device 1006 relative to XR device 1004 based on a signal from XR device 1006. At operation 1012, XR device 1004 may transmit the relative location of XR device 1006 to server 1002. Similarly, at operation 1014, XR device 1006 may determine the position of XR device 1004 relative to XR device 1006. At operation 1016, XR device 1006 may transmit the relative position of XR device 1004 to server 1002.

As another example, XR device 1004 and XR device 1006 may each determine their respective positions (e.g., based on IMU data, image data, GPS data, etc.). For instance, at operation 1010, XR device 1004 may determine a pose of XR device 1004. At operation 1012, XR device 1004 may transmit the pose of XR device 1004 to server 1002. At operation 1014, XR device 1006 may determine a pose of XR device 1006. At operation 1016, XR device 1006 may transmit the pose of XR device 1006 to server 1002. At operation 1018, server 1002 may determine the relative pose of XR device 1004 and XR device 1006.

As another example, XR device 1004 and XR device 1006 may each generate pose data (e.g., IMU data, image data, GPS data, etc.) and transmit the pose data to server 1002. For instance, at operation 1012, XR device 1004 may transmit IMU data and/or image data to server 1002. Further, at operation 1016, XR device 1006 may transmit IMU data and/or image data to server 1002. At operation 1018, server 1002 may determine the poses of XR device 1004 and XR device 1006 and the relative pose of XR device 1004 and XR device 1006.

In any case, operations 1008 through 1018 may include determining a pose of XR device 1006 relative to XR device 1004. At operation 1020, server 1002 may render image data based on the poses of XR device 1004 and XR device 1006 and based on the relative pose of XR device 1004 and XR device 1006 satisfying a condition (e.g., as described with regard to FIG. 9). For example, server 1002 may render image data for XR device 1004 based on a pose of XR device 1004 (e.g., based on the pose of XR device 1004 relative to virtual content associated with an environment of XR device 1004). Further, server 1002 may render the image data for XR device 1004 based on whether the relative pose of XR device 1004 and XR device 1006 satisfies a condition.

In some aspects, the image data rendered at operation 1020 may be, or may include, pre-rendered image data, for example, based on a predicted pose and/or predicted relative pose of XR device 1004 and XR device 1006. For example, server 1002 may render image data for XR device 1004 based on a predicted pose of XR device 1004. For instance, server 1002 may render image data of a virtual object from a predicted pose of XR device 1004. Additionally, server 1002 may determine to render the image data based on a predicted pose of XR device 1004 and a predicted pose of XR device 1006 satisfying a relative-pose condition.

At operation 1022, server 1002 may transmit the image data to XR device 1004. At operation 1024, XR device 1004 may display the image data. At operation 1026, XR device 1004 may store one or more additional images received at operation 1022. For example, XR device 1004 may store images for poses that do not correspond to a current pose of XR device 1004. At operation 1028, XR device 1004 may display an image stored at operation 1026. Operation 1022 may be the same as, or may be substantially similar to, operation 818 of FIG. 8A and FIG. 8B. Operation 1024 may be the same as, or may be substantially similar to, operation 820 of FIG. 8A and FIG. 8B. Operation 1026 may be the same as, or may be substantially similar to, operation 822 of FIG. 8A and FIG. 8B. Operation 1028 may be the same as, or may be substantially similar to, operation 824 of FIG. 8A and FIG. 8B.

Similarly, at operation 1032, server 1002 may transmit the image data to XR device 1006. At operation 1034, XR device 1006 may display the image data. At operation 1036, XR device 1006 may store one or more additional images received at operation 1032. For example, XR device 1006 may store images for poses that do not correspond to a current pose of XR device 1006. At operation 1038, XR device 1006 may display an image stored at operation 1036. Operation 1032 may be the same as, or may be substantially similar to, operation 818 of FIG. 8A and FIG. 8B. Operation 1034 may be the same as, or may be substantially similar to, operation 820 of FIG. 8A and FIG. 8B. Operation 1036 may be the same as, or may be substantially similar to, operation 822 of FIG. 8A and FIG. 8B. Operation 1038 may be the same as, or may be substantially similar to, operation 824 of FIG. 8A and FIG. 8B.

For example, two XR devices (e.g., XR device 922 and XR device 924) may present XR content to two respective users. When the two users approach each other (or move away from each other), XR content may be pre-rendered at a server and then provided to both the users. More generally, a set of unique content may be displayed by the two XR devices. The act of ‘approaching each other’ may be quantified using the relative range, and the relative speed (e.g., range <10 meters and/or range-rate of −1 meter/second). Similar to what was described with regard to FIG. 8A, the image data may be pre-rendered may be based on link quality, latency threshold, and/or potential PoVs that are ranked by likelihood of occurrence.

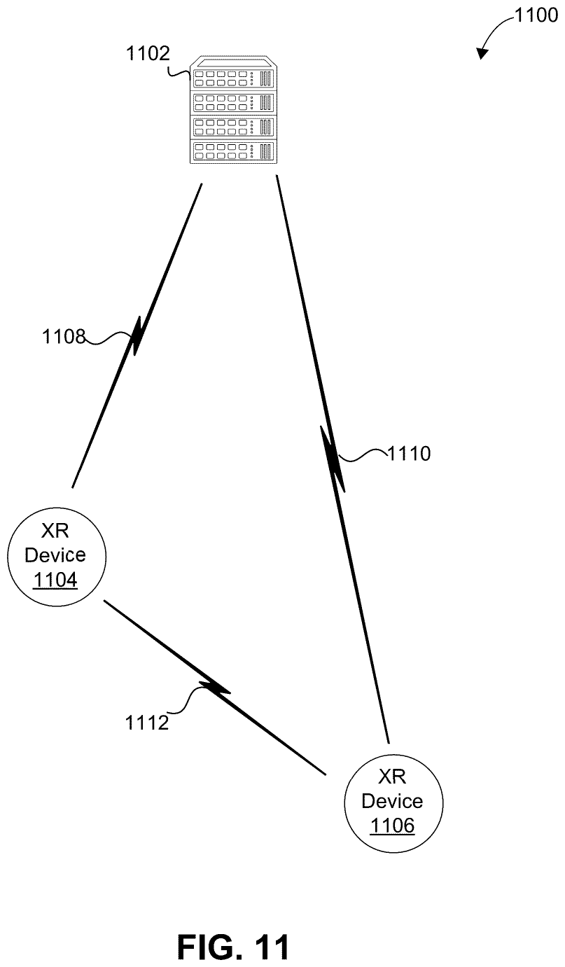

FIG. 11 is a diagram including an example system 1100 for rendering image data, according to various aspects of the present disclosure. System 1100 includes an example server 1102, and two example XR devices—an XR device 1104 and an XR device 1106. There is a communication link 1108 between server 1102 and XR device 1104, a communication link 1110 between server 1102 and XR device 1106, and a communication link 1112 between XR device 1104 and XR device 1106. Communication link 1108 and communication link 1110 may be wireless connections according to any suitable wireless protocol, such as, a broadband-cellular-network protocol, for example, a fifth generation (5G) wireless cellular protocol. Communication link 1112 may be a wireless connection according to any suitable wireless protocol, such as, for example, Institute of Electrical and Electronics Engineers (IEEE) 802.11 (Wi-Fi), IEEE 802.15, or Bluetooth®.

In some aspects, pre-rendering, according to various aspects of the present disclosure, may be performed by the XR devices when link quality to the server is poor, or the server is overloaded/down. For example, when communication link 1108 and/or communication link 1110 is poor, XR device 1104 and/or XR device 1106 may prerender image data for display by XR device 1104 and/or XR device 1106.

System 1100 may perform the same, or substantially the same operations as described with regard to process 800a of FIG. 8A, process 800b of FIG. 8B, and/or process 1000 of FIG. 10. However, whereas server 802 and server 1002 perform pre-rendering tasks (e.g., at operation 816 and operation 1020 respectively), in system 1100, the pre-rendering tasks may be allocated to one or more of the XR devices (e.g., XR device 1104 and/or XR device 1106.

In some aspects, XR device 1104 and XR device 1106 may share pre-rendered models. For example, XR device 1104 may have previously rendered certain content at location 1. XR device 1104 may share the rendered content with other XR devices in the vicinity (e.g., XR device 1106). The pre-rendered model may then be displayed when the other XR devices approach location 1.

Additionally or alternatively, XR device 1104 and XR device 1106 may participate in round-robin pre-rendering. For example, adding on to the above approach of sharing models, the XR devices may take turns to render content and share the rendered content with the rest of the group. A baseline approach would be to take turns in a round-robin manner, but XR devices may also be classified in terms of their remaining battery resources and computational capabilities. For example, XR devices with most amount of battery remaining may render more content, and/or XR devices with the least computational capability may render less content.

Additionally or alternatively, XR devices may split content to be rendered amongst the XR devices. For example, XR devices may also agree on a protocol to split the rendering tasks amongst themselves. For instance, XR device 1104 may render content ‘A’ and XR device 1106 may render content ‘B’, which are then shared between XR device 1104 and XR device 1106. The splitting may also apply to the same virtual object (such as, content ‘A’ being the top part of a virtual object while content ‘B’ is the bottom part of the virtual object).

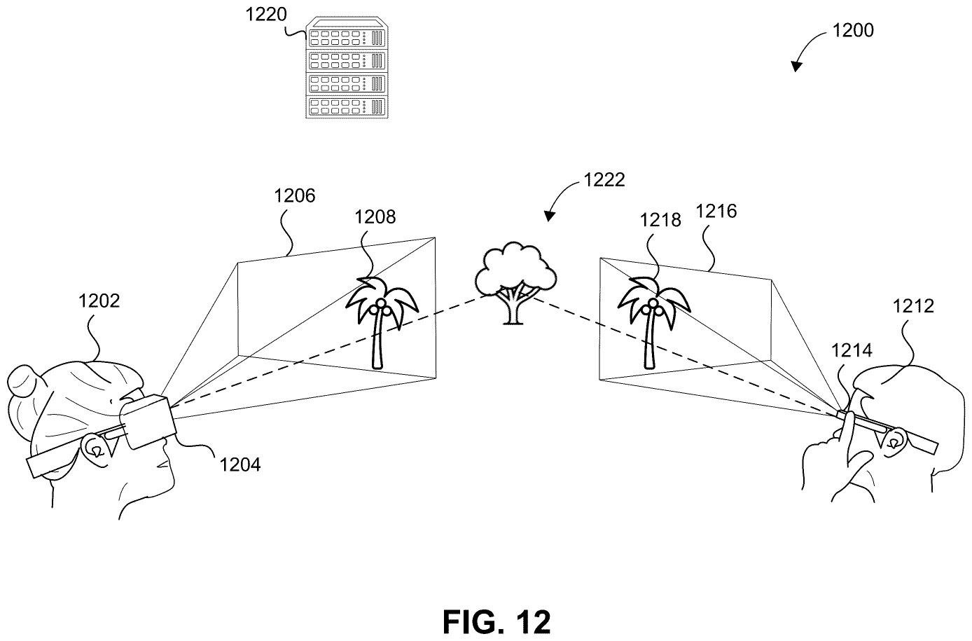

FIG. 12 is a diagram illustrating an example extended-reality (XR) system 1200, according to aspects of the disclosure. XR system 1200 may include an XR device 1204 worn by a user 1202, an XR device 1214 worn by a user 1212, and a server 1220. XR device 1204 may be an example of any of XR device 104 of FIG. 1, display device 204 and companion device 208 of FIG. 2, XR device 302 of FIG. 3, XR system 400 of FIG. 4 or XR device 604 of FIG. 6. Server 1220 may be an example of any of processing device 206 of FIG. 2, or server 606 of FIG. 6.

In some aspects, XR system 1200 may render and/or prerender image data at server 1220. Additionally or alternatively, XR system 1200 may render and/or prerender image data the XR device 1204 and/or the XR device 1214, for example, according to hybrid rendering and/or shared rendering described above.

XR system 1200 may render virtual content hierarchically. For example, XR system 1200 may render virtual content beginning with a coarse-resolution rendering and gradually refining and increasing the resolution and/or quality over time. As described above, which virtual content of a scene 1222 to render may depend on location and/or orientation of XR devices (e.g., XR device 1204 and XR device 1214) in scene 1222.

By predicting future states (locations and/or orientations) of XR device 1204 and/or XR device 1214 in scene 1222, XR system 1200 may anticipate which virtual content to prerender. XR system 1200 may predict multiple future states (e.g., poses) for each of XR device 1204 and XR device 1214 in scene 1222. Further, XR system 1200 may determine a probability associated with each of the predicted poses. Further, XR system 1200, may render virtual content associated with scene 1222 (e.g., virtual content 1208 in field of view 1206 of user 1202, virtual content 1218 in field of view 1216 of user 1212, etc.) at different resolutions in the rendering hierarchy. The resolution for different views of scene 1222 may depend on the respective probabilities of the views. (e.g., as described with regard to FIG. 7).

Additionally or alternatively, the virtual content for different predicted poses could also be analyzed for commonalities, for example to avoid duplicate rendering. For instance, virtual content associated with a portion of scene 1222 may be common to multiple predicted poses. That virtual content could be rendered at a higher resolution than other virtual content associated with scene 1222. More generally, virtual content of a portion of scene 1222 may be common to some subset of future predicted poses. XR system 1200 may compute ‘portion probability’ (e.g., as a sum of the corresponding future state probabilities) and determine the rendering resolution for each portion based on its probability.

The future state prediction and probability estimates may be determined at server 1220, at XR device 1204, at XR device 1214, and/or by a distributed algorithm executed on any or all of server 1220, XR device 1204 and XR device 1214. The predicted poses and probabilities may be based on previously-reported positions and/or orientations (and/or position-related measurements) and/or prior estimates of positions, orientations, and/or velocities of one or more of XR devices (e.g., XR device 1204, XR device 1214, other XR devices in scene 1222 and/or devices that were previously in scene 1222). The estimates may be transmitted to the XR device(s) that did not compute them but may use them for the predictive rendering.

Any or all of the XR devices described herein (e.g., XR device 104 of FIG. 1, display device 204 and companion device 208 of FIG. 2, XR device 302 of FIG. 3, XR system 400 of FIG. 4, XR device 604 of FIG. 6, XR device 806 of FIG. 8A and FIG. 8B, XR device 902 of FIG. 9, XR device 904 of FIG. 9, XR device 922 of FIG. 9, XR device 924 of FIG. 9, XR device 1004 of FIG. 10, XR device 1006 of FIG. 10, XR device 1104 of FIG. 11, XR device 1106 of FIG. 11, XR device 1204 of FIG. 12, and/or XR device 1214 of FIG. 12) may be, or may include, a user equipment (UE), according to various standards or protocols. For example, any or all of the XR devices described herein may be, or may include, a 5th generation (5G) EDGe-Dependent AR (EDGAR) UE.

For example, an XR Runtime, including the XR Spatial Compute, may be assisted by the cloud/edge application for example spatial localization and mapping provided by a spatial computing service. The XR Runtime may be a device-resident software or firmware that implements a set of application programming interfaces (APIs) to provide access to the underlying XR hardware. These APIs are referred to as XR Runtime APIs. XR Spatial computing summarizes functions which process sensor data to generate information about the world 3D space surrounding an XR user. This requires accurately localizing the XR device worn by the end-user in relation to a spatial coordinate system of the real-world space. Two example representative and standardized XR runtimes are Khronos defined OpenXR and W3C defined WebXR).

In some aspects, a Lightweight Scene Manager may be included in an XR device, but the main scene management and composition may be performed on the cloud/edge (scene provider). A scene description is generated and exchanged to establish the split workflow. A Scene Manager may be a software component that is able to process a scene description and renders the corresponding 3D scene. To render the scene, the Scene Manager may use a Graphics Engine that may be accessed by APIs such as defined by Vulkan, OpenGL, Metal, DirectX, etc. The Scene Manager may parse a scene description document to create a scene graph representation of the scene. The Scene Manager may, for instance, delegate some of the rendering tasks to an edge or remote server. As an example, the Scene Manager may only be capable of rendering a flattened 3D scene that has a single node with depth and color information. The light computation, animations, and flattening of the scene may be delegated to an edge server). Additionally, Media Access Functions may be provided that support the delivery of media content components over the 5G system, in particular cloud and split rendering supporting functions.

Any or all of the XR devices described herein may be, or may include, a Split-Rendering WireLess Tethered AR (WLAR) UE. In this case, a companion device (e.g., companion device 208) that includes a modem also acts to support rendering of complex scenes and provides the pre-rendered data to the glass.

5G connectivity is provided through a tethered device which embeds the 5G modem. Wireless tethered connectivity is provided through WiFi or 5G sidelink. BLE (Bluetooth Low Energy) connectivity may be used for audio. The motion-to-render-to-photon loop runs from the glass to the phone. While the connectivity is outside of the 5G Uu domain, it is still expected that for proper performance when used for split rendering, a stable and constant delay link may be setup on the tethered connection.

The tethered glass itself may, or may not, include a regular 5G UE, but the combination of the glass and the phone results in a regular 5G UE. While media processing (for 2D media) may be done on the XR glasses, energy intensive XR media processing may be done on the XR tethered device or split.

The location server (e.g., location server 804) may be, or may include, a location management function (LMF). Meanwhile, the rendering server/edge/cloud may comprise multiple entities such as the XR spatial description server, scene provider, media delivery function, and XR application provider.

Location measurements may be sent by the UE to the LMF. The UE application contacts the application provider to fetch the entry point for the content (an entry point may for example be a universal resource locator (URL) to a scene description). Media content (audio, images, videos, animations, etc.) may be sent from the media delivery function to the XR device. Computations associated with potential poses may be offloaded by the XR device to the XR spatial description server. The scene provider may finally pre-render the content and provide it to the XR device.

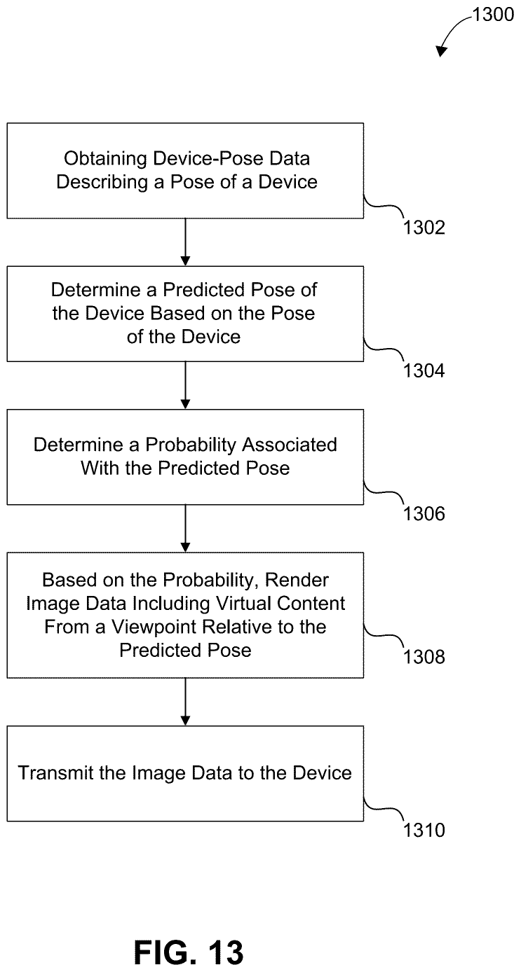

FIG. 13 is a flow diagram illustrating an example process 1300 for generating one or more images, in accordance with aspects of the present disclosure. One or more operations of process 1300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1300. The one or more operations of process 1300 may be implemented as software components that are executed and run on one or more processors.

At block 1302, a computing device (or one or more components thereof) may obtain device-pose data describing a pose of a device. For example, server 606 may obtain Pose data 610. Pose data 610 may describe a pose of XR device 604.

At block 1304, the computing device (or one or more components thereof) may determine a predicted pose of the device based on the pose of the device. For example, server 606 may determine (e.g., predict) a pose of XR device 604.

In some aspects, the pose is determined based on at least one of inertial data of an inertial measurement unit (IMU) of the device or images captured by the device. For example, XR device 604 may include an IMU and/or a camera. XR device 604 may capture IMU data and/or image data. XR device 604 may determine a pose of XR device 604 based on the IMU data and/or based on the image data.

At block 1306, the computing device (or one or more components thereof) may determine a probability associated with the predicted pose. For example, server 606 may determine a probability associated with the pose predicted at block 1304.

At block 1308, the computing device (or one or more components thereof) may based on the probability, render image data including virtual content from a viewpoint relative to the predicted pose. For example, based on the probability, server 606 may render image data 614. Image data 614 may include virtual content 612 as viewed from a viewpoint related to the pose predicted at block 1304.

At block 1310, the computing device (or one or more components thereof) may cause at least one transmitter to transmit the image data to the device. For example, server 606 may transmit image data 614 to XR device 604.

In some aspects, the predicted pose may be, or may include, a first predicted pose. The probability may be, or may include, a first probability. The image data may be, or may include, first image data. The computing device (or one or more components thereof) may determine a second predicted pose of the device based on the pose of the device; determine a second probability associated with the second predicted pose; render second image data based on the virtual content and the second predicted pose; and determine whether to transmit the second image data to the device based on the second probability. For example, server 606 may predict a second pose of XR device 604 based on pose data 610. Further, server 606 may determine a second probability related to the second predicted pose of XR device 604. Server 606 may render second image data (e.g., virtual content 612 from a viewpoint associated with the second predicted pose of XR device 604). Server 606 may determine whether to transmit the second image data to XR device 604 based on the second probability.

In some aspects, the image data represents a portion of the virtual content based on the predicted pose of the device relative to a position associated with the virtual content. For example, image data 614 may be, or may include, a portion of virtual content 612 (e.g., a portion of one virtual object) based on the predicted pose of XR device 604 relative to a position associated with virtual content 612.

In some aspects, the portion of the virtual content comprises a subset of a plurality of virtual objects of the virtual content or wherein the portion of the virtual content a section of a virtual object of the virtual content. For example, image data 614 may be, or may include, a portion of virtual content 612 (e.g., a subset of a number of virtual objects) based on the predicted pose of XR device 604 relative to a position associated with virtual content 612.

In some aspects, the computing device (or one or more components thereof) may obtain at least one of communication statistics or rendering-capability data, wherein the communication statistics describe an ability of a server to communicate with the device, and wherein the rendering-capability data describes an ability of the device to render image data; and render the image data based on at least one of the communication statistics or the rendering-capability data. For example, server 606 may obtain communication statistics and/or rendering-capability data. For instance, XR device 604 may provide rendering-capability data and/or communication statistics to server 606. Additionally or alternatively, server 606 may measure or observe communication statistics. The communication statistics may describe an ability of XR device 604 to communicate with server 606. The rendering-capability data may describe an ability of XR device 604 to render image data. Server 606 may determine to render image data 614 based on the communication statistics and/or the rendering-capability data.

In some aspects, the computing device (or one or more components thereof) may obtain communication statistics, wherein the communication statistics describe an ability of a server to communicate with the device. The image data is rendered based on a latency of the communication statistics. For example, server 606 may obtain communication statistics. For instance, XR device 604 may provide communication statistics to server 606. Additionally or alternatively, server 606 may measure or observe communication statistics. The communication statistics may describe an ability of XR device 604 to communicate with server 606. Server 606 may determine to render image data 614 based on latency of the communication statistics.

In some aspects, the computing device (or one or more components thereof) may obtain communication statistics, wherein the communication statistics describe an ability of a server to communicate with the device; determine a display condition associated with the image data based on a latency of the communication statistics; and cause then at least one transmitter to transmit the display condition to the device. For example, server 606 may obtain communication statistics. For instance, XR device 604 may provide communication statistics to server 606. Additionally or alternatively, server 606 may measure or observe communication statistics. Server 606 may determine a display condition based on the communication statistic. For example, server 606 may determine when to display image data 614 (e.g., a time for XR device 604 to display image data 614 or a pose of XR device 604 from which XR device 604 may display image data 614) based on the communication statistic. Server 606 may transmit the display condition to XR device 604. XR device 604 may display image data 614 based on the display condition.

In some aspects, the display condition may be, or may include, a time to display the image data. For example, server 606 may determine a time for XR device 604 to display image data 614 based on a latency of communication between server 606 and XR device 604.

In some aspects, the display condition may be, or may include, a pose from which to display the image data. For example, server 606 may determine a pose from which XR device 604 is to display image data 614 based on a latency of communication between server 606 and XR device 604.

In some aspects, the computing device (or one or more components thereof) may determine a rendering quality based on the probability associated with the predicted pose, wherein the image data is rendered at the rendering quality. For example, server 606 may determine a quality at which to render image data 614 based on a probability associated with a pose associated with image data 614.

In some aspects, the device may be, or may include, a first device. The device-pose data may be, or may include, first device-pose data. The image data may be, or may include, first image data. The computing device (or one or more components thereof) may obtain second device-pose data, wherein the second device-pose data describes a pose of a second device; determine a relative pose between the first device and the second device; render second image data based on the relative pose; and cause the at least one transmitter to transmit the second image data to the first device. For example, server 606 may obtain second device-pose data from a second XR device. The second device-pose data may describe the pose of the second device. Server 606 may determine a relative pose between XR device 604 and the second device. Server 606 may render image data based on the relative pose. Server 606 may transmit the image data (e.g., to the XR device 604).

In some aspects, a computing device (or one or more components thereof) (e.g., a computing device (or one or more components thereof) of XR device 604 may obtain, at a first extended reality (XR) device, image data, wherein the image data is based on virtual content associated with a location, wherein the image data is rendered at a server based on a predicted pose of the first XR device and based on a probability associated with the predicted pose; and cause at least one transmitter to transmit the image data from the first XR device to a second XR device in the location. For example, server 606 may obtain second device-pose data from a second XR device. The second device-pose data may describe the pose of the second device. Server 606 may determine a relative pose between XR device 604 and the second device. Server 606 may render image data based on the relative pose. Server 606 may transmit the image data (e.g., to the XR device 604). XR device 604 may transmit the image date to the second XR device.

In some examples, as noted previously, the methods described herein (e.g., process 800a of FIG. 8A, process 800b of FIG. 8B, process 1000 of FIG. 10, process 1300 of FIG. 13, and/or other methods described herein) can be performed, in whole or in part, by a computing device or apparatus. In one example, one or more of the methods can be performed by server 606 of FIG. 6, server 802 of FIG. 8A or FIG. 8B, server 1002 of FIG. 10, server 1102 of FIG. 11, server 1220 of FIG. 12, XR device 104 of FIG. 1, display device 204 and companion device 208 of FIG. 2, XR device 302 of FIG. 3, XR system 400 of FIG. 4, XR device 604 of FIG. 6, XR device 806 of FIG. 8A and FIG. 8B, XR device 902 of FIG. 9, XR device 904 of FIG. 9, XR device 922 of FIG. 9, XR device 924 of FIG. 9, XR device 1004 of FIG. 10, XR device 1006 of FIG. 10, XR device 1104 of FIG. 11, XR device 1106 of FIG. 11, XR device 1204 of FIG. 12, and/or XR device 1214 of FIG. 12, or by another system or device. In another example, one or more of the methods (e.g., process 800a, process 800b, process 1000, process 1300, and/or other methods described herein) can be performed, in whole or in part, by the computing-device architecture 1400 shown in FIG. 14. For instance, a computing device with the computing-device architecture 1400 shown in FIG. 14 can include, or be included in, the components of the server 606 of FIG. 6, server 802 of FIG. 8A or FIG. 8B, server 1002 of FIG. 10, server 1102 of FIG. 11, server 1220 of FIG. 12, XR device 104 of FIG. 1, display device 204 and companion device 208 of FIG. 2, XR device 302 of FIG. 3, XR system 400 of FIG. 4, XR device 604 of FIG. 6, XR device 806 of FIG. 8A and FIG. 8B, XR device 902 of FIG. 9, XR device 904 of FIG. 9, XR device 922 of FIG. 9, XR device 924 of FIG. 9, XR device 1004 of FIG. 10, XR device 1006 of FIG. 10, XR device 1104 of FIG. 11, XR device 1106 of FIG. 11, XR device 1204 of FIG. 12, and/or XR device 1214 of FIG. 12 and can implement the operations of process 1300, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 800a, process 800b, process 1000, process 1300, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 800a, process 800b, process 1000, process 1300, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 14 illustrates an example computing-device architecture 1400 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1400 may include, implement, or be included in any or all of server 606 of FIG. 6, server 802 of FIG. 8A or FIG. 8B, server 1002 of FIG. 10, server 1102 of FIG. 11, server 1220 of FIG. 12, XR device 104 of FIG. 1, display device 204 and companion device 208 of FIG. 2, XR device 302 of FIG. 3, XR system 400 of FIG. 4, XR device 604 of FIG. 6, XR device 806 of FIG. 8A and FIG. 8B, XR device 902 of FIG. 9, XR device 904 of FIG. 9, XR device 922 of FIG. 9, XR device 924 of FIG. 9, XR device 1004 of FIG. 10, XR device 1006 of FIG. 10, XR device 1104 of FIG. 11, XR device 1106 of FIG. 11, XR device 1204 of FIG. 12, and/or XR device 1214 of FIG. 12 and/or other devices, modules, or systems described herein. Additionally or alternatively, computing-device architecture 1400 may be configured to perform process 800a of FIG. 8A, process 800b of FIG. 8B, process 1000 of FIG. 10, process 1300 of FIG. 13, and/or other process described herein.

The components of computing-device architecture 1400 are shown in electrical communication with each other using connection 1412, such as a bus. The example computing-device architecture 1400 includes a processing unit (CPU or processor) 1402 and computing device connection 1412 that couples various computing device components including computing device memory 1410, such as read only memory (ROM) 1408 and random-access memory (RAM) 1406, to processor 1402.

Computing-device architecture 1400 can include a cache of high-speed memory connected directly with, in close proximity to, or integrated as part of processor 1402. Computing-device architecture 1400 can copy data from memory 1410 and/or the storage device 1414 to cache 1404 for quick access by processor 1402. In this way, the cache can provide a performance boost that avoids processor 1402 delays while waiting for data. These and other modules can control or be configured to control processor 1402 to perform various actions. Other computing device memory 1410 may be available for use as well. Memory 1410 can include multiple different types of memory with different performance characteristics. Processor 1402 can include any general-purpose processor and a hardware or software service, such as service 1 1416, service 2 1418, and service 3 1420 stored in storage device 1414, configured to control processor 1402 as well as a special-purpose processor where software instructions are incorporated into the processor design. Processor 1402 may be a self-contained system, containing multiple cores or processors, a bus, memory controller, cache, etc. A multi-core processor may be symmetric or asymmetric.

To enable user interaction with the computing-device architecture 1400, input device 1422 can represent any number of input mechanisms, such as a microphone for speech, a touch-sensitive screen for gesture or graphical input, keyboard, mouse, motion input, speech and so forth. Output device 1424 can also be one or more of a number of output mechanisms known to those of skill in the art, such as a display, projector, television, speaker device, etc. In some instances, multimodal computing devices can enable a user to provide multiple types of input to communicate with computing-device architecture 1400. Communication interface 1426 can generally govern and manage the user input and computing device output. There is no restriction on operating on any particular hardware arrangement and therefore the basic features here may easily be substituted for improved hardware or firmware arrangements as they are developed.

Storage device 1414 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1406, read only memory (ROM) 1408, and hybrids thereof. Storage device 1414 can include services 1416, 1418, and 1420 for controlling processor 1402. Other hardware or software modules are contemplated. Storage device 1414 can be connected to the computing device connection 1412. In one aspect, a hardware module that performs a particular function can include the software component stored in a computer-readable medium in connection with the necessary hardware components, such as processor 1402, connection 1412, output device 1424, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for generating one or more images, the apparatus comprising: at least one memory; and at least one processor coupled to the at least one memory and configured to: obtain device-pose data describing a pose of a device; determine a predicted pose of the device based on the pose of the device; determine a probability associated with the predicted pose; based on the probability, render image data including virtual content from a viewpoint relative to the predicted pose; and cause at least one transmitter to transmit the image data to the device.

Aspect 2. The apparatus of aspect 1, wherein the predicted pose comprises a first predicted pose, wherein the probability comprises a first probability, wherein the image data comprises first image data, wherein the at least one processor is configured to: determine a second predicted pose of the device based on the pose of the device; determine a second probability associated with the second predicted pose; render second image data based on the virtual content and the second predicted pose; and determine whether to transmit the second image data to the device based on the second probability.

Aspect 3. The apparatus of any one of aspects 1 or 2, wherein the image data represents a portion of the virtual content based on the predicted pose of the device relative to a position associated with the virtual content.

Aspect 4. The apparatus of aspect 3, wherein the portion of the virtual content comprises a subset of a plurality of virtual objects of the virtual content or wherein the portion of the virtual content a section of a virtual object of the virtual content.

Aspect 5. The apparatus of any one of aspects 1 to 4, wherein the at least one processor is configured to: obtain at least one of communication statistics or rendering-capability data, wherein the communication statistics describe an ability of a server to communicate with the device, and wherein the rendering-capability data describes an ability of the device to render image data; and render the image data based on at least one of the communication statistics or the rendering-capability data.

Aspect 6. The apparatus of any one of aspects 1 to 5, wherein the at least one processor is configured to: obtain communication statistics, wherein the communication statistics describe an ability of a server to communicate with the device; wherein the image data is rendered based on a latency of the communication statistics.

Aspect 7. The apparatus of any one of aspects 1 to 6, wherein the at least one processor is configured to: obtain communication statistics, wherein the communication statistics describe an ability of a server to communicate with the device; determine a display condition associated with the image data based on a latency of the communication statistics; and cause then at least one transmitter to transmit the display condition to the device.

Aspect 8. The apparatus of aspect 7, wherein the display condition comprises a time to display the image data.

Aspect 9. The apparatus of any one of aspects 7 or 8, wherein the display condition comprises a pose from which to display the image data.

Aspect 10. The apparatus of any one of aspects 1 to 9, wherein the at least one processor is configured to determine a rendering quality based on the probability associated with the predicted pose, wherein the image data is rendered at the rendering quality.

Aspect 11. The apparatus of any one of aspects 1 to 10, wherein the device comprises a first device, wherein the device-pose data comprises first device-pose data, and wherein the image data comprises first image data, wherein the at least one processor is configured to: obtain second device-pose data, wherein the second device-pose data describes a pose of a second device; determine a relative pose between the first device and the second device; render second image data based on the relative pose; and cause the at least one transmitter to transmit the second image data to the first device.

Aspect 12. The apparatus of any one of aspects 1 to 11, wherein the pose is determined based on at least one of inertial data of an inertial measurement unit (IMU) of the device or images captured by the device.

Aspect 13. An apparatus for generating one or more images, the apparatus comprising: at least one memory; and at least one processor coupled to the at least one memory and configured to: obtain, at a first extended reality (XR) device, image data, wherein the image data is based on virtual content associated with a location, wherein the image data is rendered at a server based on a predicted pose of the first XR device and based on a probability associated with the predicted pose; and cause at least one transmitter to transmit the image data from the first XR device to a second XR device in the location.

Aspect 14. A method for generating one or more images, the method comprising: obtaining device-pose data describing a pose of a device; determining a predicted pose of the device based on the pose of the device; determining a probability associated with the predicted pose; based on the probability, rendering image data including virtual content from a viewpoint relative to the predicted pose; and transmitting the image data to the device.

Aspect 15. The method of aspect 14, wherein the predicted pose comprises a first predicted pose, wherein the probability comprises a first probability, wherein the image data comprises first image data, the method further comprising: determining a second predicted pose of the device based on the pose of the device; determining a second probability associated with the second predicted pose; rendering second image data based on the virtual content and the second predicted pose; and determining whether to transmit the second image data to the device based on the second probability.

Aspect 16. The method of any one of aspects 14 or 15, wherein the image data represents a portion of the virtual content based on the predicted pose of the device relative to a position associated with the virtual content.

Aspect 17. The method of aspect 16, wherein the portion of the virtual content comprises a subset of a plurality of virtual objects of the virtual content or wherein the portion of the virtual content a section of a virtual object of the virtual content.

Aspect 18. The method of any one of aspects 14 to 17, further comprising: obtaining at least one of communication statistics or rendering-capability data, wherein the communication statistics describe an ability of a server to communicate with the device, and wherein the rendering-capability data describes an ability of the device to render image data; and rendering the image data based on at least one of the communication statistics or the rendering-capability data.

Aspect 19. The method of any one of aspects 14 to 18, further comprising: obtaining communication statistics, wherein the communication statistics describe an ability of a server to communicate with the device; wherein the image data is rendered based on a latency of the communication statistics.

Aspect 20. The method of any one of aspects 14 to 19, further comprising: obtaining communication statistics, wherein the communication statistics describe an ability of a server to communicate with the device; determining a display condition associated with the image data based on a latency of the communication statistics; and transmitting the display condition to the device.

Aspect 21. The method of aspect 20, wherein the display condition comprises a time to display the image data.

Aspect 22. The method of any one of aspects 20 or 21, wherein the display condition comprises a pose from which to display the image data.

Aspect 23. The method of any one of aspects 14 to 22, further comprising determining a rendering quality based on the probability associated with the predicted pose, wherein the image data is rendered at the rendering quality.

Aspect 24. The method of any one of aspects 14 to 23, wherein the device comprises a first device, wherein the device-pose data comprises first device-pose data, and wherein the image data comprises first image data, the method further comprising: obtaining second device-pose data, wherein the second device-pose data describes a pose of a second device; determining a relative pose between the first device and the second device; rendering second image data based on the relative pose; and transmitting the second image data to the first device.

Aspect 25. The method of any one of aspects 14 to 24, wherein the pose is determined based on at least one of inertial data of an inertial measurement unit (IMU) of the device or images captured by the device.

Aspect 26. A method for generating one or more images, the method comprising: obtaining, at a first extended reality (XR) device, image data, wherein the image data is based on virtual content associated with a location, wherein the image data is rendered at a server based on a predicted pose of the first XR device and based on a probability associated with the predicted pose; and transmitting the image data from the first XR device to a second XR device in the location.

Aspect 27. A non-transitory computer-readable storage medium having stored thereon instructions that, when executed by at least one processor, cause the at least one processor to perform operations according to any of aspects 14 to 26.

Aspect 28. An apparatus for providing virtual content for display, the apparatus comprising one or more means for perform operations according to any of aspects 14 to 26.

What is claimed is:

1. An apparatus for generating one or more images, the apparatus comprising:
at least one memory; and
at least one processor coupled to the at least one memory and configured to:
obtain device-pose data describing a pose of a device;
determine a predicted pose of the device based on the pose of the device;
determine a probability associated with the predicted pose;
based on the probability, render image data including virtual content from a viewpoint relative to the predicted pose; and
cause at least one transmitter to transmit the image data to the device.

2. The apparatus of claim 1, wherein the predicted pose comprises a first predicted pose, wherein the probability comprises a first probability, wherein the image data comprises first image data, wherein the at least one processor is configured to:
determine a second predicted pose of the device based on the pose of the device;
determine a second probability associated with the second predicted pose;
render second image data based on the virtual content and the second predicted pose; and
determine whether to transmit the second image data to the device based on the second probability.

3. The apparatus of claim 1, wherein the image data represents a portion of the virtual content based on the predicted pose of the device relative to a position associated with the virtual content.

4. The apparatus of claim 3, wherein the portion of the virtual content comprises a subset of a plurality of virtual objects of the virtual content or wherein the portion of the virtual content a section of a virtual object of the virtual content.

5. The apparatus of claim 1, wherein the at least one processor is configured to:
obtain at least one of communication statistics or rendering-capability data, wherein the communication statistics describe an ability of a server to communicate with the device, and wherein the rendering-capability data describes an ability of the device to render image data; and
render the image data based on at least one of the communication statistics or the rendering-capability data.

6. The apparatus of claim 1, wherein the at least one processor is configured to:
obtain communication statistics, wherein the communication statistics describe an ability of a server to communicate with the device;
wherein the image data is rendered based on a latency of the communication statistics.

7. The apparatus of claim 1, wherein the at least one processor is configured to:
obtain communication statistics, wherein the communication statistics describe an ability of a server to communicate with the device;
determine a display condition associated with the image data based on a latency of the communication statistics; and
cause then at least one transmitter to transmit the display condition to the device.

8. The apparatus of claim 7, wherein the display condition comprises a time to display the image data.

9. The apparatus of claim 7, wherein the display condition comprises a pose from which to display the image data.

10. The apparatus of claim 1, wherein the at least one processor is configured to determine a rendering quality based on the probability associated with the predicted pose, wherein the image data is rendered at the rendering quality.

11. The apparatus of claim 1, wherein the device comprises a first device, wherein the device-pose data comprises first device-pose data, and wherein the image data comprises first image data, wherein the at least one processor is configured to:
obtain second device-pose data, wherein the second device-pose data describes a pose of a second device;
determine a relative pose between the first device and the second device;
render second image data based on the relative pose; and
cause the at least one transmitter to transmit the second image data to the first device.

12. The apparatus of claim 1, wherein the pose is determined based on at least one of inertial data of an inertial measurement unit (IMU) of the device or images captured by the device.

13. An apparatus for generating one or more images, the apparatus comprising:
at least one memory; and
at least one processor coupled to the at least one memory and configured to:
obtain, at a first extended reality (XR) device, image data, wherein the image data is based on virtual content associated with a location, wherein the image data is rendered at a server based on a predicted pose of the first XR device and based on a probability associated with the predicted pose; and
cause at least one transmitter to transmit the image data from the first XR device to a second XR device in the location.

14. A method for generating one or more images, the method comprising:
obtaining device-pose data describing a pose of a device;
determining a predicted pose of the device based on the pose of the device;
determining a probability associated with the predicted pose;
based on the probability, rendering image data including virtual content from a viewpoint relative to the predicted pose; and
transmitting the image data to the device.

15. The method of claim 14, wherein the predicted pose comprises a first predicted pose, wherein the probability comprises a first probability, wherein the image data comprises first image data, the method further comprising:
determining a second predicted pose of the device based on the pose of the device;
determining a second probability associated with the second predicted pose;
rendering second image data based on the virtual content and the second predicted pose; and
determining whether to transmit the second image data to the device based on the second probability.

16. The method of claim 14, wherein the image data represents a portion of the virtual content based on the predicted pose of the device relative to a position associated with the virtual content.

17. The method of claim 16, wherein the portion of the virtual content comprises a subset of a plurality of virtual objects of the virtual content or wherein the portion of the virtual content a section of a virtual object of the virtual content.

18. The method of claim 14, further comprising:
obtaining at least one of communication statistics or rendering-capability data, wherein the communication statistics describe an ability of a server to communicate with the device, and wherein the rendering-capability data describes an ability of the device to render image data; and
rendering the image data based on at least one of the communication statistics or the rendering-capability data.

19. The method of claim 14, further comprising:
obtaining communication statistics, wherein the communication statistics describe an ability of a server to communicate with the device;
wherein the image data is rendered based on a latency of the communication statistics.

20. The method of claim 14, further comprising:
obtaining communication statistics, wherein the communication statistics describe an ability of a server to communicate with the device;
determining a display condition associated with the image data based on a latency of the communication statistics; and
transmitting the display condition to the device.
